(19) United States
(12) Patent Application Publication
(10) Pub. No.: US 2025/0190809 A1
(43) Pub. Date: Jun. 12, 2025

(54) Reinforcement Machine-Learned Spectrum Analysis

(71) Applicant: BATTELLE ENERGY ALLIANCE, LLC, Idaho Falls, ID (US)

(72) Inventors: Matthew W Anderson, Idaho Falls, ID (US); Ryan G Fronk, Idaho Falls, ID (US); Edward L Reber, Idaho Falls, ID (US); Dawn M Scates, Idaho Falls, ID (US); Michael A Reichenberger, Idaho Falls, ID (US)

(73) Assignee: BATTELLE ENERGY ALLIANCE, LLC, Idaho Falls, ID (US)

(21) Appl. No.: 18/845,343

(22) PCT Filed: Mar. 16, 2023
(86) PCT No.: PCT/US23/64603

§ 371 Date: Sep. 9, 2024

Related U.S. Application Data
(60) Provisional application No. 63/320,674, filed on Mar. 16, 2022.

(51) Int. Cl. G06N 3/092

(52) U.S. Cl. CPC G06N 3/092

(57) ABSTRACT

The present disclosure describes aspects of systems and methods for machine-learned spectrum analysis. A policy may be learned through an unsupervised reinforcement machine learning procedure. The procedure may comprise training an actor to determine actions in an environment. The actor may be trained based, at least in part, on rewards determined for the actions by an adversarial network, such as a critic. The critic may learn a value function through supervised learning. By contrast, the actor may learn the policy the unsupervised reinforcement learning. The system may generate training data comprising noise configured to model noise likely to exist during real world operation in different use cases. Policies may be trained for different use cases using training data configured to include noise characteristic of the different use cases.

### CROSS-REFERENCE TO RELATED APPLICATIONS

This application claims priority to PCT Application No. PCT/US23/64603 filed Mar. 16, 2023, which claims priority to U.S. Provisional Patent No. Application No. 63/320,674, filed Mar. 16, 2022, each of which is hereby incorporated by reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### BACKGROUND

Unless otherwise indicated herein, the approaches described in this section are not prior art to the claims in this disclosure and are not admitted to be prior art by inclusion in this section.

Spectrum analysis techniques involve numerical analysis, which can introduce uncertainty into the analysis results. For instance, radioisotopes can be identified by detecting characteristic peaks within radiation spectra. The characteristic peaks are often identified and measured using numerical techniques, such as peak or curve fitting, e.g., fitting data points of spectra to a mathematical model, such as a polynomial, cubic spline, Gaussian model, or the like. The use of these types of numerical techniques can have significant disadvantages. For example, numerical curve fitting can become unreliable when applied to spectra data having relatively high, or relatively low data rates (e.g., high or low count rates), background noise, multiple peaks, overlapping peaks, and/or the like. Moreover, these techniques can be sensitive to changes resulting from geometry changes (e.g., jitter or other perturbations with respect to position of a detector relative to the target), environmental changes, and so on. As such, accurate spectral analysis may require expert human interaction, which can be time consuming, expensive, and prone to human error and/or bias.

Spectrum analysis is known to be a “regression problem.” In other words, spectrum analysis falls into the class of problems that are known to be suitable for regression-type analysis techniques. Regression analysis is a set of statistical processes and techniques for estimating and/or predicting relationships between dependent variables (referred to as “outcome” or “response” variables) and independent variables (referred to as “predictors”, “covariates”, “explanatory variables” or “features”). For example, a regression model for spectrum analysis may utilize independent variables acquired from a target (e.g., spectrum data, spectrum image data, counts at respective wavelengths or energies, or the like) to determine a set of dependent variables configured to estimate the presence or quantity of respective radioisotopes of interest within the target.

Those of skill in the art have developed machine-learning models for regression problems, such as spectrum analysis. These “regression” machine-learning models include supervised machine-learning models, such as artificial neural networks (ANN), convolutional ANN, classifiers, and so on. Regression-type machine learning techniques, however, may not be capable of adapting to environmental changes and/or noise conditions without expert intervention.

### BRIEF DESCRIPTION OF THE DRAWINGS

Examples of systems, methods, devices, and computer-readable storage media comprising instructions configured to implement aspects of reinforcement machine learning or machine learned (RML) spectrum analysis are set forth in the accompanying figures and detailed description:

FIG. 1A illustrates an example operating environment including an apparatus that can implement aspects of RML spectrum analysis, as disclosed herein.

FIG. 1B illustrates examples of spectrum analysis features.

FIG. 1C illustrates further examples of spectrum analysis features.

FIG. 2A illustrates an example of a device configured to implement aspects of ML emission spectrum analysis.

FIG. 2B illustrates an example of a device configured to implement aspects of RML radiation spectroscopy.

FIG. 3A illustrates an example of a gamma spectrum.

FIG. 3B illustrates an example of an automated curve fit operation.

FIG. 3C illustrates an example of an interactive curve fit operation.

FIG. 4A illustrates an example of an apparatus configured to implement aspects of an unsupervised machine-learning procedure.

FIG. 4B illustrates an example of a state space for a spectrum analysis application.

FIG. 4C illustrates an example of an RML policy.

FIG. 4D illustrates another example of an RML policy.

FIG. 4E illustrates another example of an apparatus configured to implement aspects of an RML procedure.

FIG. 5A illustrates an example of a device configured to implement one of a plurality of learned spectrum analysis applications.

FIG. 5B illustrates an example of a hardware-based apparatus for spectrum analysis.

FIG. 6 illustrates an example of a spectrum analysis device configured to generate training data comprising noise signals.

FIG. 7A is a flow diagram illustrating an example of a method for machine-learned spectrum analysis.

FIG. 7B is a flow diagram illustrating another example of a method for machine-learned spectrum analysis.

FIG. 8 is a flow diagram illustrating an example of a method for generating training data for learning a spectrum analysis application and/or use case thereof.

### DETAILED DESCRIPTION

As discussed above, spectrum analysis is considered to be a “regression problem,” i.e., a problem suitable for regression analysis. Regression-type, supervised machine learning models have been developed for this class of problems. Other machine learning architectures, such as unsupervised, reinforcement machine learning models have been developed to address different types of problems (e.g., non-regression problems). These other machine learning models are not considered to be suitable for regression-type problems, such as spectrum analysis. For example, these types of models are typically more complex and involve more computational overhead than regression-type models. It can be difficult to apply these techniques to and/or learn from high-dimensional inputs, such as spectrum data. Moreover, the reinforcement or reward structure used in these types of machine models may not be well defined for regression-type problems.

Although these and other factors lead away from the use of reinforcement learning techniques for spectrum analysis, the inventors defied convention and invested in the development of systems and methods to apply unsupervised, reinforcement machine learning to aspects of spectrum analysis. As disclosed in further detail herein, this novel approach has yielded unexpected results. The inventors determined, through testing and experience, that the unsupervised, reinforcement machine-learning techniques disclosed herein, such actor/critic techniques, can be used to implement aspects of spectrum analysis that are more accurate and less susceptible to environmental changes (e.g., different types of noise and/or background signals) than other approaches, such as regression-type machine learning.

Disclosed herein are examples of methods for machine-learned spectrum analysis. Examples of the disclosed methods may include defining a state space corresponding to a spectrum analysis application, the spectrum analysis application comprising determining predictions for respective labels of a plurality of labels. The defining may comprise configuring dimensions of the state space to represent respective labels of the plurality of labels of the spectrum analysis application. The method may further include learning a policy configured to implement the spectrum analysis application in an RML procedure. The RML procedure may comprise processing an entry of a training dataset over a plurality of steps corresponding to a RML environment, the RML environment comprising a state of the state space and spectrum data of the entry. Embodiments of the method may comprise utilizing the policy learned through the RML procedure to produce predictions for respective labels of the spectrum analysis application in response to acquired spectrum data.

Disclosed herein are examples of a device configured to implement machine-learned spectrum analysis. The device may comprise a processor coupled to a memory; and a reinforcement machine-learned (RML) policy configured for operation on the processor. The RML policy may be configured to predict emission values for respective labels in response to spectrum input data, each label configured to represent a respective radioisotope of a plurality of radioisotopes of interest. The RML policy may be learned through an unsupervised RML procedure implemented within an RML architecture comprising an actor and critic. The RML procedure may comprise processing entries of a training dataset over a plurality of iterations, each iteration comprising: configuring the actor to determine an action configured to modify a state comprising predictions for the respective labels, configuring the critic to determine a reward for the action, and updating the RML policy of the actor in accordance with the determined reward.

Disclosed herein are examples of a system for machine-learned spectrum analysis. Embodiments of the system may comprise a processor coupled to a memory; and a training module configured to learn a policy configured to implement a spectrum analysis application, the spectrum analysis application comprising determining predictions for respective labels of a plurality of labels of the spectrum analysis application in response to spectra.

The training module may comprise an RML environment configured to model a state space of the spectrum analysis application, wherein the state space is configured to include dimensions representing respective labels of the spectrum analysis application, an actor, and a critic. The training module may be configured to learn the policy through implementation of an RML procedure, the RML procedure comprising processing entries of a training dataset, each entry processed over a plurality of time steps, and wherein processing an entry at a time step t comprises: configuring the actor to take an action at time step t, the action generated by the policy based on a state of the RML environment at time step t, the state comprising predictions for respective labels of the spectrum analysis application, wherein the action is configured to modify one or more of the predictions, configuring the critic to determine a reward for the action taken an time step t based, at least in part, on known prediction values for the plurality of labels, and updating the policy in accordance with the determined reward. The system may further include an RML module configured to utilize the policy learned through implementation of the RML procedure to produce predictions for respective labels of the spectrum analysis application in response to acquired spectrum data.

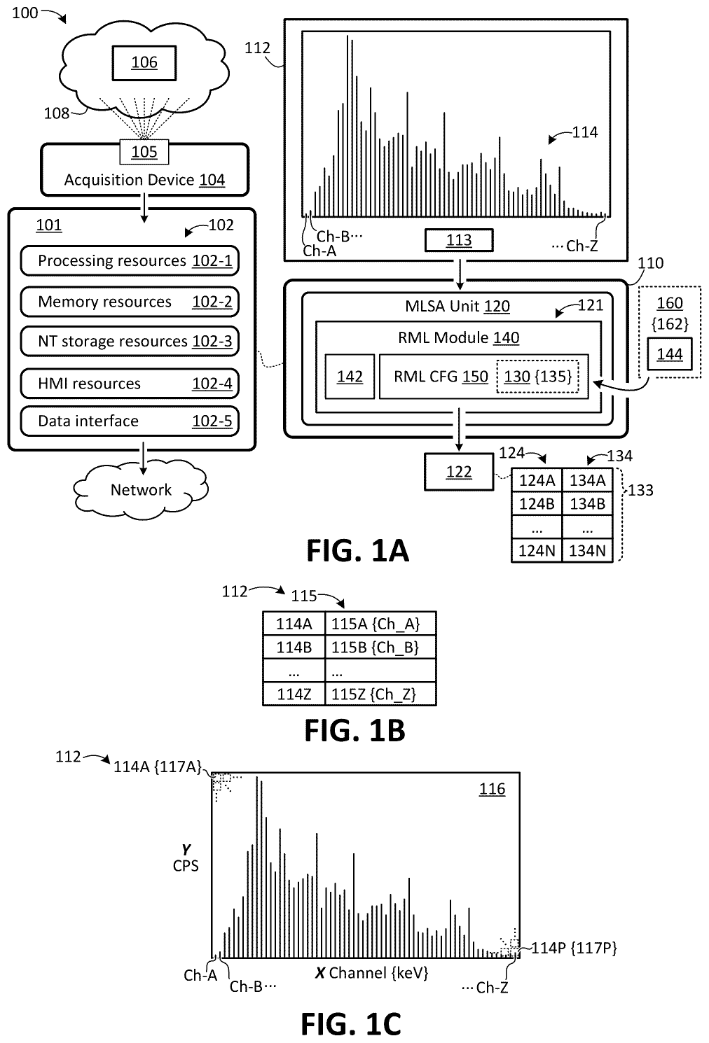

FIG. 1A illustrates an example of a system 100 comprising an apparatus 101 configured to implement aspects of ML spectrum analysis (MLSA), e.g., a spectrum analysis system 100. The apparatus 101 may comprise and/or be embodied by one or more physical components, which may include, but are not limited to: an electronic device, a computing device, a general-purpose computing device, an application-specific computing device, a mobile computing device, a smart phone, a tablet, a laptop, a server device, a distributed computing system, a cloud-based computing system, an embedded computing system, and/or the like.

As illustrated in FIG. 1A, the apparatus 101 may comprise and/or be coupled to computing resources 102, which may include, but are not limited to: processing resources 102-1, memory resources 102-2, non-transitory (NT) storage resources 102-3, human-machine interface (HMI) resources 102-4, a data interface 102-5, and/or the like. The processing resources 102-1 may comprise any suitable processing means including, but not limited to: processing circuitry, logic circuitry, an integrated circuit (IC), a processor, a processing unit, a physical processor, a virtual processor (e.g., a virtual machine), an arithmetic-logic unit (ALU), a central processing unit (CPU), a general-purpose processor, a programmable logic device (PLD), a field programmable gate array (FPGA), an application-specific integrated circuit (ASIC), a System on Chip (SoC), virtual processing resources, and/or the like.

The memory resources 102-2 may comprise any suitable memory means including, but not limited to: volatile memory, non-volatile memory, random access memory (RAM), dynamic RAM (DRAM), synchronous DRAM (SDRAM), cache memory, or the like. The NT storage resources 102-3 may comprise any suitable non-transitory, persistent, and/or non-volatile storage means including, but not limited to: a non-transitory storage device, a persistent storage device, an internal storage device, an external storage device, a remote storage device, Network Attached Storage (NAS) resources, a magnetic disk drive, a hard disk drive (HDD), a solid-state storage device (SSD), a Flash memory device, and/or the like.

The HMI resources 102-4 may comprise any suitable means for human-machine interaction including, but not limited to: input devices, output devices, input/output (I/O) devices, visual output devices, display devices, monitors, touch screens, a keyboard, gesture input devices, a mouse, a haptic feedback device, an audio output device, a neural interface device, and/or the like.

The data interface 102-5 may comprise any suitable data communication and/or interface means including, but not limited to: a communication interface, a I/O interface, a device interface, a network interface, an interconnect, and/or the like. In some implementations, the data interface 102-5 may be configured to communicatively couple the MLSA device 110 to a network, which may include, but is not limited to: an electronic communication network, a computer network, a wired network, a wireless network, a local area network (LAN), a wide area network (WAN), a virtual private network (VPN), Internet Protocol (IP) networks, Transmission Control Protocol/Internet Protocol (TCP/IP) networks, the Internet, or the like.

The apparatus 101 may comprise an ML spectrum analysis (MLSA) device 110. The MLSA device 110 be implemented and/or embodied by computing resources 102 of the apparatus 101. For example, the MLSA device 110 may be configured for operation on processing resources 102-1 of the apparatus 101, utilize memory resources 102-2 of the apparatus 101, be embodied by computer-readable instructions stored within NT storage resources 102-3 of the apparatus 101, and so on. The MLSA device 110 may comprise an artificial intelligence/ML (AI/ML) platform, an AI/ML processing environment, an AI/ML processing toolkit, an AI/ML processing library and/or the like. Alternatively, or in addition, aspects of the MLSA device 110 may be implemented and/or realized by hardware components, such as application-specific processing hardware, an ASIC, FPGA, an ML processor, dedicated memory resources, and/or the like.

In some implementations, the MLSA device 110 may comprise and/or be coupled to an MLSA unit 120 (or MLSA application unit 120). The MLSA unit 120 may be configured to implement aspects of any suitable SA application 130 (e.g., any “target” SA application 130) including, but not limited to: electro-optical (EO) spectroscopy, visible spectroscopy, infrared (IR) or vibrational spectroscopy, ultraviolet (UV) spectroscopy, UV and visible spectroscopy, absorption spectroscopy, atomic absorption spectroscopy, astronomical spectroscopy, circular dichroism spectroscopy, electrochemical impedance spectroscopy (EIS), electron spin resonance (ESR) spectroscopy, emission spectroscopy, energy dispersive spectroscopy, fluorescence spectroscopy, Fourier-transform infrared (FTIR) spectroscopy, x-ray photoelectron spectroscopy (or x-ray spectroscopy), gamma-ray spectroscopy (or gamma spectroscopy), mass spectroscopy, radioisotopic spectroscopy, radioisotope spectroscopy (e.g., radioisotope identification and/or quantification), radioisotope spectroscopy mass spectroscopy, magnetic resonance spectroscopy, nuclear magnetic resonance (NMR) spectroscopy, molecular spectroscopy, Mossbauer spectroscopy, photoelectron spectroscopy, Raman spectroscopy, and/or the like.

The MLSA unit 120 may implement aspects of the SA application 130 by use of a reinforcement machine-learning and/or machine-learned (RML) module 140. The RML module 140 may comprise any suitable reinforcement AI/ML means including, but not limited to one or more: ANN, convolutional ANN (CNN), multilayer perceptron (MLP) networks, recurrent or recursive neural networks, actor/critic (AC) RML components, and/or the like. As disclosed in further detail herein, the RML module 140 may be trained to implement aspects of the SA application 130 through a reinforcement machine learning (RML) procedure 160. The RML procedure 160 may comprise, be implemented, and/or embodied by a reinforcement machine-learning model or (RML architecture 162, as disclosed in further detail herein.

The RML procedure 160 may comprise developing and/or refining reinforcement machine-learned configuration (RML CFG) data 150. As used herein, RML CFG data 150 (or an RML CFG 150) may refer to and/or comprise any suitable information pertaining to the implementation of an SA application 130 by machine learned and/or machine-learning (ML) components 121 of the MLSA unit 120. As disclosed in further detail herein, the RML CFG 150 may comprise configuration data adapted to configure the RML module 140 to implement aspects of the SA application 130, e.g., hyperparameters, such as ANN node weights, interconnections, and/or the like.

In some implementations, the RML procedure 160 may comprise learning a policy 142 configured to implement a target SA application 130. In other words, the policy 142 may be learned and/or refined through reinforcement machine learning techniques, such as actor/critic RML and, as such, may be referred to as an RML policy 142. The policy 142 may comprise one or more ML components 121, such as an MLP, an ANN, a CNN, a combination of ML components 121, and/or the like.

The policy 142 may be trained to implement aspects of an SA application 130, which may comprise processing SA inputs 112 comprising spectrum data and, in response, generating predictions 124 for respective labels 134 of the SA application 130. For example, the policy 142 may be configured to implement a radiation spectroscopy SA application, which may comprise receiving spectrum data pertaining to a subject 106 and, in response, predicting the quantity of one or more radioisotopes within the subject 106 (e.g., and/or predict the emission level of respective radioisotopes

The RML procedure 160 may comprise training the policy 142 using rewards and/or projected rewards produced by an evaluator or adversarial network, such as critic 144, or the like. As disclosed in further detail herein, the critic 144 may be configured to assess the utility of actions taken by an “actor” (e.g., the policy 142) and, in response, provide the actor with rewards, which may be used to train and/or refine the policy 142. The critic 144 may comprise one or more ML components 121, such as one or more MLP, ANN, CNN, a combination of ML components 121, and/or the like. During training, the critic 144 may be configured to learn a value function V configured to produce rewards that accurately reflect the utility of the actions taken by the actor 142. During deployment, the RML module 140 may implement aspects of the SA application 130 by use of the trained policy 142 (e.g., without the need for the critic 144 or other adversarial ML components 121).

As disclosed herein, in some embodiments, implementing the SA application 130 may comprise processing spectrum analysis (SA) input data 112. As used herein, SA input data 112 (or an SA input 112) may refer to any suitable input data of an SA application 130. An SA input 112 may comprise spectrum data pertaining a target or subject 106. As used herein, a “subject” 106 may refer to any suitable source or potential source of spectrum data (e.g., any source of radiation), including, but not limited to, an object, an item, a container, cargo, an area, a cargo area, a region, a volume, a substance, a material, a vehicle, a person, a fusion product, reactor fuel sample, an experiment, or any other subject of passively or actively acquired SA input data 112. Alternatively, or in addition, in some implementations, SA input data 112 may comprise spectrum data captured from and/or within an acquisition region 108. As used herein, the acquisition region 108 of an SA input 112 may comprise and/or refer to the region in which the corresponding spectrum data was acquired or captured, which may include, but is not limited to an area, space, three-dimensional space, environment, expanse, field of view (FoV), coordinates (e.g., volumetric coordinates), and/or the like. For example, the acquisition region 108 of an SA input 112 may comprise and/or refer to the detection area and/or FoV of the instrument(s) used to acquire the spectrum data of the SA input 112.

In the FIG. 1A example, the MLSA device 110 may be configured to process SA input data 112 corresponding to a spectral range, a range of frequencies, energies, wavelengths, and/or the like. In some implementations, the SA input data 112 may comprise continuous spectrum data, e.g., may comprise spectrum data defined over a specified spectral range (e.g., a specified range of frequencies, wavelengths, energies, or the like). Alternatively, or in addition, the SA input data 112 may comprise discrete spectrum data; the SA input data 112 may comprise a series of values corresponding to respective spectral locations or channels. As used herein, a “spectrum channel” or “channel” may refer to a specified location, position, offset, region, extent, or range within a spectrum; for example, a spectrum may comprise channels corresponding to respective frequencies (or frequency ranges), respective wavelengths (or wavelength ranges), respective energy levels (or energy ranges), or the like.

The MLSA unit 120 may be configured to process SA input data 112 pertaining to any suitable type of radiation and/or particle including, but not limited to: EO radiation, EO spectra, EO radiation spectra, optical spectra, emission spectra, ionizing radiation spectra, high-energy EO radiation spectra, gamma spectra, x-ray spectra, nuclear decay spectra, alpha decay spectra, beta decay spectra, gamma decay spectra, and/or the like.

In some implementations, the MLSA unit 120 may be configured to process acquired SA input data 112. As used herein, acquired SA input data 112 may refer to SA input data 112 that comprises and/or corresponds to spectrum data obtained by use of an acquisition device 104, e.g., measured, actual, experimental, “real-world,” or “raw” spectrum data. As used herein, an acquisition device 104 may comprise and/or refer to any suitable means for acquiring spectrum data, which may include, but is not limited to: a spectrometer, an optical spectrometer, an EO spectrometer, an EO radiation spectrometer, a gamma ray spectrometer, an x-ray spectrometer, a neutron spectrometer, a gas chromatography spectrometer, a mass spectrometer, a passive acquisition device, an active acquisition device, and/or the like. In some embodiments, an acquisition device 104 may comprise and/or embody one or more sensor(s) 105. As used herein, a sensor 105 may comprise any suitable means for sensing, collecting, quantifying, detecting, capturing, and/or otherwise acquiring spectrum data pertaining to a subject 106 and/or region 108. For example, a sensor 105 may comprise one or more of: a particle detector, a radiation detector, a gamma-ray detector, a gamma-ray counter, a gamma-ray spectrometer (GRS), a neutron detector, an ionization detector, a gaseous ionization detector, a gas-filled (GF) detector, an ionization chamber GF detector, a proportional counter GF detector, a Geiger-Mueller (G-M) tube GF detector, a scintillation (SCT) device, an SCT counter, a photomultiplier tube (PMT) detector, a silicon photomultiplier, a charge-coupled device (CCD) detector, a photodiode detector, a gamma-ray detector, a neutron detector, a lithium-doped Ge (Ge(Li)) SCT detector, a thallium-activated sodium iodide SCT detector (or NaI(Tl) SCT detector), a Cherenkov detector, a microchannel plate detector, a solids-state or semiconductor-based (SCD) detector, a silicon vertex detector, a semiconductor diode SCD detector, a germanium (Ge) SCD detector, an p-type Ge detector, an n-type Ge detector, and/or the like.

As illustrated in the FIG. 1A example, in some implementations, the MLSA device 110 may be communicatively and/or operatively coupled to an acquisition device 104. The MLSA device 110 may be configured to process SA input data 112 captured by the acquisition device 104. The disclosure is not limited in this regard, however. In some implementations, the MLSA device 110 may be configured to process SA input data 112 acquired by a separate, external acquisition device 104. For example, the MLSA device 110 may be configured to process SA input data 112 retrieved from an electronic communication network, SA input data 112 stored on a computer-readable storage medium, such as NT storage resources 102-3, and/or the like. Alternatively, or in addition, the MLSA unit 120 may be configured to process other types of SA input data 112, such as SA inputs 112 comprising synthetically generated spectrum data, hybrid spectrum data (e.g., a combination of acquired spectrum data and one or more synthetic signals, such as noise signals), and/or the like.

In some implementations, SA input data 112 may comprise and/or be associated with SA metadata 113. As used herein, SA metadata 113 may comprise and/or refer to any suitable information pertaining to SA input data 112 including, but not limited to: a spectral range covered by the SA input data 112, channels of the SA input data 112, a resolution of the SA input data 112, information pertaining to features 114 of the SA input data 112 (as disclosed in further detail herein), information pertaining to the subject 106 of the SA input data 112, information pertaining to the acquisition region 108 of the SA input data 112, information pertaining to the acquisition device 104 used to acquire the SA input data 112 (e.g., device model, firmware, configuration, settings, and/or the like), Information pertaining to the sensor 105 used to acquire the SA input data 112 (e.g., detector type, settings, configuration, and/or the like), information pertaining to the region 108 in which the spectrum data 112 was acquired (e.g., location, environment, and/or the like), information pertaining to the orientation of the target 106 relative to the acquisition device 104 and/or sensor 105, information pertaining to generation of synthetic and/or hybrid spectrum data of the SA input data 112, and/or the like.

In some examples, the MLSA device 110 may be configured to receive SA input data 112 through and/or by use of the data interface 102-5. The data interface 102-5 maybe configured to communicatively and/or operatively couple the MLSA device 110 to the acquisition device 104. The MLSA device 110 may, for example, configure the acquisition device 104 to acquire SA input data 112 suitable for the SA application 130 implemented by the MLSA unit 120. Alternatively, or in addition, the MLSA unit 120 may be configured to analyze previously captured SA input data 112, synthetic SA input data 112, hybrid SA input data 112, and/or the like. For example, the data interface 102-5 may be configured to communicatively and/or operatively couple the MLSA device 110 to a data store comprising SA input data 112 (e.g., acquired SA input data, synthetic SA input data 112, hybrid SA input data 112, and/or the like), computer-readable storage comprising SA input data 112 (e.g., NT storage resources 102-3), a network-accessible data store comprising SA input data 112, means for generating synthetic and/or hybrid SA input data 112, and/or the like.

Implementing the SA application 130 may comprise generating SA output data 122 in response to SA input data 112. As used herein, SA output data 122 (or an SA output 122) may refer to any suitable information pertaining to analysis of an SA input 112. The MLSA unit 120 may be configured to generate SA output data 122 comprising predictions 124 for respective SA labels 134. As used herein, an SA label 134 (or label 134) may refer to information configured to model, represent, classify, and/or characterize any suitable aspect, output, or result of an SA application 130. SA labels 134 may include, but are not limited to: classifications, classes, tags, text, labels, semantic classifications, semantic classes, semantic tags, semantic text, semantic labels, symbols, codes, qualitative data, quantitative data, and/or the like. For example, the SA labels 134 may define a set of radioisotopes of interest (RoI) and the predictions 124 determined for the respective SA labels 134 may indicate a likelihood that the corresponding RoI are present in the subject 106 of the SA input 112 (and/or predict a quantity of the respective RoI).

As used herein, a prediction 124 (or prediction data 124) may refer to any suitable information pertaining to analysis of an SA input 112 with respect to an SA label 134. The MLSA unit 120 may be configured to generate any suitable type of prediction data 124 in response to an SA input 112, including, but not limited to: data indicating the presence (or absence) of respective labels 134 within the SA input 112 (and/or corresponding subject 106), data indicating a probability of the presence of the label 134, data indicating the presence (or absence) of a specified activity level of the label 134 within the SA input 112, data indicating a probability of the specified activity level, data indicating a quantity of a label 134 within the subject 106 associated with the SA input 112, data indicating an estimated accuracy (or uncertainty) of predictions 124 determined for respective labels 134, and/or the like.

In the FIG. 1A example, the MLSA unit 120 may be configured to determine predictions 124 for a set of N labels 134 (e.g., determine predictions 124A-N for labels 134A-N, respectively). In other words, the N labels 134 may comprise a search space or vocabulary 133 of the SA application 130. In some embodiments, information pertaining to the SA application 130 implemented by the MLSA unit 120 may be defined in spectrum analysis application (SAA) metadata 135. As used herein, SAA metadata 135 may comprise any suitable information pertaining to an SA application 130, including, but not limited to: characteristics of the SA input data 112 utilized in the SA application (e.g., may comprise and/or reference aspects of the SA metadata 113, such as the type of spectrum data utilized in the SA application 130, the resolution of the SA input data 112, a number of channels included in the SA input data 112, characteristics of image-based SA input data 112, and/or the like), characteristics of the SA output data 122 to be generated for respective SA inputs 112 (e.g., the vocabulary 133 and/or labels 134 to be predicted for the SA input 112), and so on.

The RML module 140 may be trained to implement aspects of any suitable SA application 130 (through execution of a suitable RML procedure 160): in a first non-limiting example, the RML CFG 150 may be adapted to configure the RML module 140 (and/or policy 142) to implement aspects to an SA application 130 pertaining to emission spectroscopy, which may comprise predicting element(s) present within emission spectra of respective SA inputs 112, e.g., generating SA outputs 122 comprising predictions 124 for labels 134 corresponding to respective elements of interest; in a second non-limiting example, the RML CFG 150 may be adapted to configure the RML module 140 (and/or policy 142) to implement aspects of an SA application 130 pertaining to radioisotope spectroscopy, which may comprise generating SA outputs 122 comprising predictions 124 indicating the quantity and/or emission level of respective RoI within radiation spectra of respective SA inputs 122; and so on.

A prediction 124 determined for an SA label 134 of an SA application 130 pertaining to emission spectroscopy may be configured to: indicate the presence (or absence) of characteristic emission(s) of a specified element of interest (EoI) within the SA input 112 (e.g., within an emission spectrum of the SA input 112), indicate a probability that the SA input 112 comprises characteristic emission(s) of the specified element, indicate an emission level of the characteristic emission(s) (e.g., indicate a level of emission at characteristic energies and/or emission lines of the specified element), quantity emission of the specified element (e.g., quantify emission(s) at characteristic peak(s) or emission line(s) of the specified element), indicate the presence (or absence) of the specified element within the subject 106 of the SA input 112 (e.g., based on the presence or absence of the characteristic emission(s) of the specified element), indicate a probability that the subject 106 comprises the specified element, indicate a quantity or concentration of the specified element within the subject 106 (e.g., based on activity at characteristic emission level(s) of the specified element), and/or the like.

A prediction 124 determined for an SA label 134 of an SA application 130 pertaining to radioisotope spectroscopy may be configured to: indicate the presence (or absence) of radiation at energy level(s) characteristic of a specified RoI within the SA input 112 (e.g., within a gamma spectrum of the SA input 112), indicate the presence (or absence) of peaks at characteristic energy level(s) of the specified radioisotope, indicate a probability that the SA input 112 comprises characteristic radiation of the specified radioisotope (e.g., based on emissions and/or peaks at characteristic energy level(s) of the specified radioisotope, if any), indicate an emission level of the specified radioisotope within the SA input 112 (e.g., indicate an emission level of peak(s) at characteristic energy level(s) of the specified radioisotope, if any), quantify emission of the specified radioisotope within the SA input 112 (e.g., quantify emission under characteristic peak(s) of the specified radioisotope, if any), indicate the presence (or absence) of the specified radioisotope within the subject 106 of the SA input 112 (e.g., based on the presence or absence of characteristic emission(s) of the specified radioisotope), indicate a probability that the subject 106 comprises the specified radioisotope, indicate a quantity or concentration of the specified radioisotope within the subject 106 (e.g., based on the emission level of the specified radioisotope type), and/or the like.

As disclosed in further detail herein, the MLSA unit 120 may be configured to extract and/or analyze features 114 of respective SA inputs 112. As used herein, a feature 114 (or SA feature 114) of SA input data 112 may refer to any suitable property or characteristic of the SA input data 112. The MLSA unit 120 may be configured to extract and/or analyze features 114 of any suitable type, e.g., in accordance with the SA application 130 implemented by the MLSA unit 120.

FIG. 1B illustrates a first non-limiting example of SA input data 112. In the FIG. 1B example, the MLSA unit 120 may be configured to analyze features 114 configured to quantify spectral activity at or within respective channels (Ch). More specifically, the MLSA unit 120 may be configured to analyze features 114A-Z of the SA input data 112, the features 114A-Z comprising activity quantities 115A-Z configured to indicate an intensity, energy, count, and/or other measure of spectral activity at or within channels Ch_A through Ch_Z of the SA input 112.

In a first non-limiting example, the SA input data 112 may correspond to an emission spectrum and the activity quantities 115A-Z may be configured to quantify an intensity of EO radiation at respective frequencies or wavelengths (or counts at respective energies). In a second non-limiting example, the SA input data 112 illustrated in FIG. 1B may comprise measurements of higher-energy EO radiation, such as a gamma-ray spectrum, x-ray spectrum, or the like. In these examples, the activity quantities 115A-Z may comprise counts, counts per second (CPS), counts per minute (CPM), or other measure of EO radiation detected at respective energy levels.

Although examples of SA input data 112 are described herein, the disclosure is not limited in this regard and could be adapted to process any suitable type of SA input data 112 (e.g., SA input data 112 comprising any number of channels or bins). In some implementations, the MLSA unit 120 may be configured to analyze SA inputs 112 comprising graphical, image-based spectrum (GSA) data 116. FIG. 1C illustrates an example of an SA input 112 comprising GSA data 116. As used herein, GSA data 116 (or a GSA 116) may refer to a graphical, visual and/or image-based representation of SA input data 112, e.g., a graphical, visual, and/or image-based representation of a spectrum or spectral data. In the FIG. 1C example, the SA input 112 may comprise a gamma-ray spectrum and the GSA 116 may comprise an image of a cartesian plot in which the vertical axis (Y) corresponds to intensity (e.g., CPS) and the horizontal axis (X) corresponds to energy level (e.g., channels Ch_A through Ch_Z). The MLSA device 110 may be configured to extract and/or analyze features 114 of the GSA 116. In the FIG. 1C example, the SA input data 112 comprises features 114A-P, each comprising and/or corresponding a respective GSA feature 117; the GSA features 117A-P may comprise respective regions of the GSA 116, such as respective pixels, pixel groups, non-overlapping pixel groups, overlapping pixel groups, image patches, and/or the like.

As disclosed herein, the MLSA device 110 may be configured to implement any suitable SA application 130. For example, the MLSA device 110 may be configured to implement an SA application 130 pertaining to emission spectroscopy. In other words, the RML CFG 150 of the MLSA unit 120 may be adapted to configure the RML module 140 (and/or policy 142) to analyze SA inputs 112 comprising emission spectra. Chemical elements emit EO radiation at characteristic frequencies, which may be represented as peaks or emission lines within emission spectra. Accordingly, peaks within an SA input 112 comprising an emission spectrum of a subject 106 may indicate which elements are present within the subject 106. Moreover, the intensity or amplitude of the peaks may indicate the quantity or concentration of respective elements.

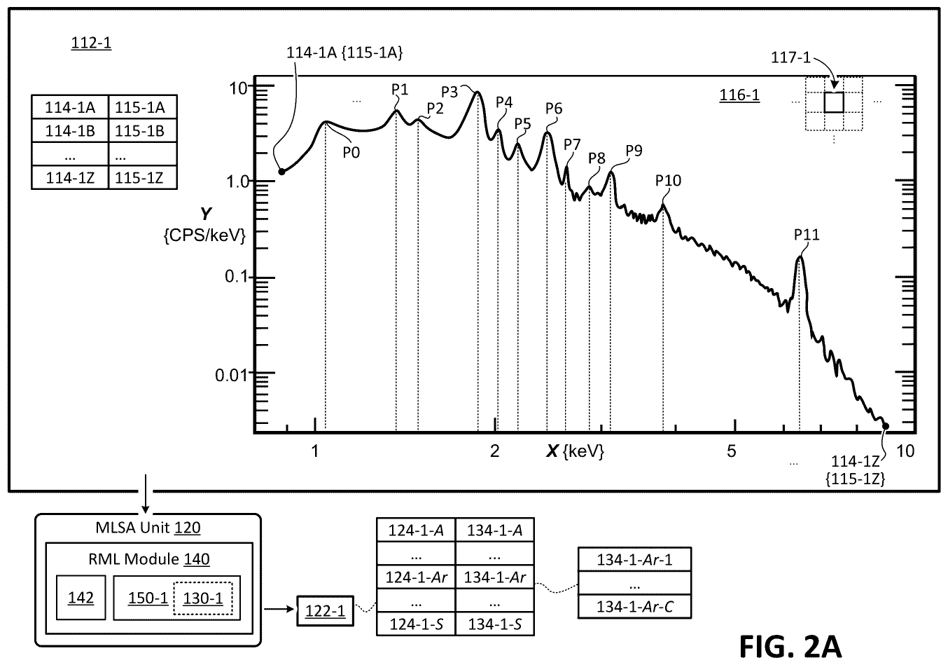

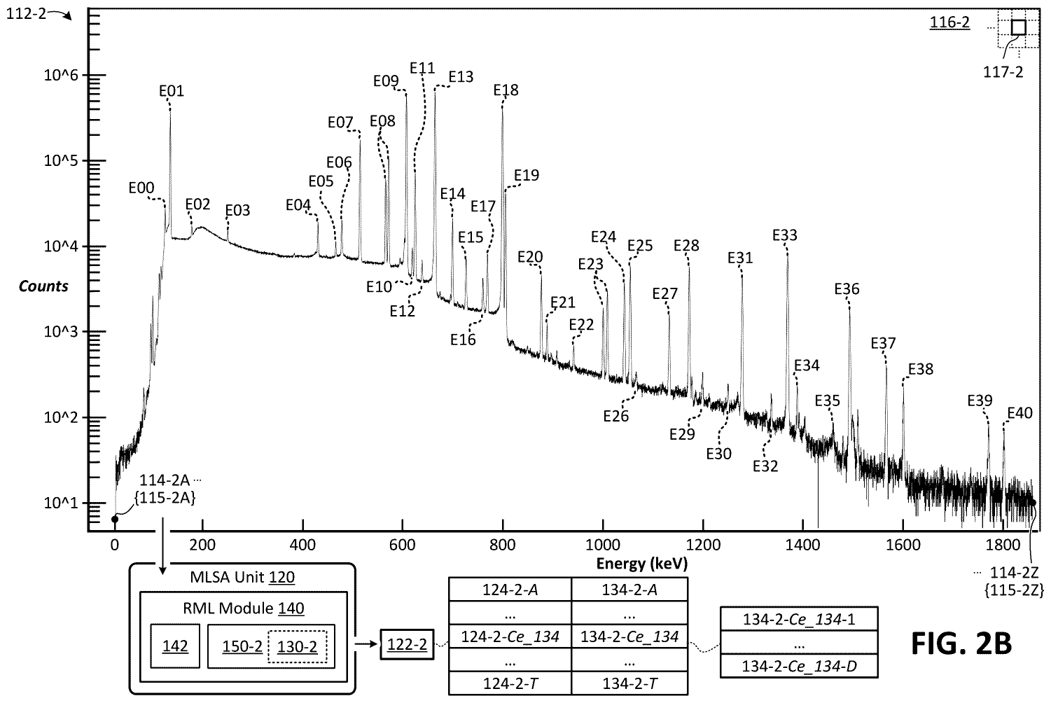

FIG. 2A illustrates an example of an MLSA unit 120 configured to implement aspects of an SA application 130-1 for emission spectroscopy. In the FIG. 2A example, the MLSA unit 120 may be configured to process emission spectra, e.g., SA input data 112-1 that comprises and/or corresponds to emission spectra. The subject 106 of the SA input data 112-1 may comprise any suitable subject 106 of emission spectroscopy, such as a substance, chemical compound, astronomical object (e.g., star, nebula, or remnant of a supernova), and/or the like. In some implementations, the MLSA unit 120 may be configured to extract and/or analyze quantitative features 114 of the SA input 112 (e.g., features 114-1A through 114-1Z). The features 114-1A through 114-1Z may comprise activity quantities 115-1A through 115-1Z configured to indicate an intensity of the emission spectrum at respective energy levels (from about 0.5 keV or lower up to about 10 keV or higher). In some implementations, the SA input 112-1 may be organized into channels (e.g., Ch_A through Ch_Z) and the activity quantities 115-1A through 115-1Z of features 114-1A through 114-1Z may comprise CPS or other measures of emission intensity at channels Ch_A through Ch_Z, respectively. Alternatively, or in addition, the MLSA device 110 may be configured to extract and/or analyze graphical, image-based features 114-1, which may comprise and/or correspond to respective GSA features 117-1 of graphical, image-based SA input data 112-1, as disclosed herein.

The example emission spectrum of the SA input 112-1 illustrated in FIG. 2A may comprise peaks at characteristic energies of respective elements; peak P0 may be characteristic of Neon (Ne), P1-P2 may be characteristic of Magnesium (Mg), P3-P5 may be characteristic of Silicon (Si), P6-P8 may be characteristic of Sulfur(S), P9 may be characteristic of Argon (Ar), P10 may be characteristic of Calcium (Ca), P11 may be characteristic of Iron (Fe), and so on.

Although examples of elements having specified characteristics energies and/or emission lines are described herein, the disclosure is not limited in this regard and could be adapted for analysis of SA input data 112-1 corresponding to any suitable elements having any suitable characteristics.

The RML CFG 150-1 may be adapted to configure the MLSA unit 120 to generate SA output 122-1 in response to emission spectra (e.g., in response to features 114-1 of SA input data 112-1 comprising emission spectra). As disclosed in further detail herein, the RML CFG 150-1 may be learned, developed, and/or refined in one or more ML procedures. In the FIG. 2A example, the RML CFG 150-1 may be learned by training the MLSA unit 120 (and/or ML components 140 thereof) to accurately identify and/or quantify characteristic emissions of respective elements of interest within emission spectra.

The RML CFG 150-1 may be adapted to configure the MLSA unit 120 to predict labels 134-1 of a vocabulary 133 determined for the emission spectroscopy SA application 130-1. As illustrated in FIG. 2A, the RML CFG 150-1 may configure the MLSA unit 120 to generate SA output data 122-1 comprising predictions 124-1-A through 124-1-S for labels 134-1-A through 126-1-S, respectively. The labels 134-1-A through 126-1-S may correspond to respective EoI of the SA application 130-1, e.g., may correspond to characteristic emission(s) and/or emission line(s) of Ne, Mg, Si, S, Ar, Ca, Fe, and/or other EoI of the SA application 130-1.

The RML CFG 150-1 may be adapted to configure the RML module 140 (and/or policy 142) to predict the presence (or absence) of respective EoI. By way of non-limiting example, the SA output 122-1 generated by the MLSA device 110 may comprise prediction data 124-1-Ar for a label 134-1-Ar configured to represent Argon. The label 134-1-Ar may correspond to characteristic emission of Argon at about 3.10 keV and the prediction data 124-1-Ar determined by the MLSA unit 120 may indicate the presence (or absence) of Argon within the emission spectrum of the SA data 112-1 (e.g., may indicate a probability that the SA input 112-1 comprises emission characteristic of Ar at 3.10 keV and, as such, whether Argon is present within the subject 106).

In some implementations, the RML CFG 150-1 may be adapted to configure the RML module 140 to predict emission levels of respective elements of interest (e.g., predict quantities or concentrations of respective elements). For example, the RML CFG 150-1 may be adapted to configure the RML module 140 to determine prediction data 124-1-Ar for a plurality of “Argon” labels 134-1-Ar-1 through 126-1-Ar-C, each configured to represent a respective emission level of Argon (e.g., each covering a respective activity or emission level at the 3.10 keV characteristic emission energy of Argon) and, hence, a respective quantity or concentration of Argon within the subject 106. The prediction data 124-1-Ar determined for the SA input 112-1 may indicate a probably that the emission spectrum comprises emission(s) characteristic of Argon at the emission levels represented by the respective “Argon” labels 134-1-Ar-A through 126-Ar-C. Hence, the prediction data 124-1-Ar may indicate the probability that the subject 106 of the SA input 112-1 comprises Argon in the quantities or concentrations represented by the respective “Argon” labels 134-1-Ar-1 through 126-1-Ar-C.

Alternatively, or in addition, the RML CFG 150-1 may be adapted to configure the RML module 140 to determine predictions 124-1 for labels 134-1 configured to quantity characteristic emission(s) of respective EoI. In other words, the RML CFG 150-1 may configure the RML module 140 to generate predictions 124-1 for labels 134-1 configured to quantify emission at characteristic energy level(s) or characteristic emission line(s) of respective EoI. For example, the prediction data 124-1-Ar and/or label 134-1-Ar may be configured to quantify the emission level of Argon within the emission spectrum of the SA input 112-1, e.g., quantify emission at characteristic peak(s) of Argon (e.g., at 3.10 keV). The determined emission level of Argon may indicate the quantity or concentration of Argon within the subject 106 of the SA input 112-2, as disclosed herein (without the need to predict a plurality of “Argon” labels 134-1-Ar-1 through 126-1-Ar-C representing different emission levels of Argon).

As disclosed herein, the MLSA device 110 may be configured to implement other types of SA applications 130. For example, the MLSA device 110 may be configured to implement SA applications 130 pertaining to radioisotope spectroscopy. The MLSA device 110 may be configured to predict labels 134 corresponding to respective RoI, e.g., identify and/or quantify respective radioisotopes or R RoI. As used herein, a “radioisotope” may refer to a material that emits EO energy, such as radiation. A radioisotope may comprise and/or refer to a radionuclide, a radioactive nuclide, a radioactive isotope, a radioactive material, and/or the like. A radioisotope may comprise and/or refer a material that is subject to nuclear decay, such as alpha decay, beta decay, gamma decay, or the like. Alpha decay is a nuclear decay process in which an unstable nucleus of a radioisotope (e.g., a radionuclide) changes to another element, resulting in emission of an alpha (a) particle (e.g., a helium nucleus comprising two protons and two neutrons). In beta decay, a nucleon of an unstable nucleus of the radioisotope is transformed into a different type, resulting in emission of a beta (B) particle or β-ray (e.g., an electron in beta minus decay and neutrino in beta plus decay). In gamma decay, high-energy gamma radiation (γ-rays) are released as subatomic particles of the radioisotope (e.g., protons and/or neutrons) transition from high-energy states to lower-energy states.

Radioisotopes may be associated with characteristic radiation, e.g., radioisotopes may emit EO radiation at characteristics energies and/or energy levels. Accordingly, EO radiation emitted by a radioisotope during nuclear decay may be distinguishable from EO radiation produced by other sources, such as other elements, other types of radioisotopes, background radiation, noise, and/or the like. The MLSA device 110 may be configured to detect, identify, and/or quantify the radioisotopes within respective subjects 106 based on EO radiation spectra of the subjects 106 (e.g., SA input data 112).

In some implementations, the MLSA unit 120 may be configured to analyze SA input data 112 comprising EO radiation spectra within the gamma nuclear range (gamma spectra). As used herein, “gamma spectral data” or “gamma spectra” refers to SA input data 112 that comprises and/or spans gamma radiation energies, e.g., spectra ranging from about 1 keV (or lower) up to about 2000 keV or higher. As disclosed herein, gamma spectra may be acquired by any suitable acquisition device 104 and/or sensor 105 inclufing, but not limited to: a radiation detector, a radiation spectrometer, a gamma-ray detector, a gamma-ray counter, a gamma-ray spectrometer (GRS), a scintillation (SCT) detector, a SCT counter, a Sodium Iodide SCT detector, a Thallium-doped Sodium Iodide (NaI(Tl)) SCT detector, a lithium-doped Germanium (Ge(Li)) SCT detector, a semiconductor-based (SCD) detector, a Germanium SCD detector, a Cadmium Telluride SCD detector, a Cadmium Zinc Telluride SCD detector, or the like. In SCT-based devices, the energy of detected gamma photons may be determined based on the intensity of corresponding flashes produced within a scintillator or scintillation counter (e.g., based on the number of low-energy photons produced by respective high-energy gamma photons). In SCD-based devices, the energy of detected gamma photons may be determined based on the magnitude of electrical signals produced by the gamma photons (e.g., the magnitude of corresponding voltage or current signals).

FIG. 2B illustrates an example of an MLSA unit 120 configured to an SA application 130 for radioisotope spectroscopy. In the FIG. 2B example, the RML module 140 (and/or Policy 142) may be configured to extract and/or analyze features 114-2 of gamma spectra, e.g., analyze SA input data 112-2 that comprises and/or corresponds to gamma spectra. In some implementations, the features 114-2 may comprise activity quantities 115-2 configured to indicate an intensity of EO radiation at energy levels ranging from about 0 keV (activity quantity 115-2A of feature 114-2A) up to about 1850 keV (activity quantity 115-2Z of feature 114-2Z). The activity quantities 115-2 may comprise counts, CPS, CPM, or other measures of radiation intensity, as disclosed herein. In some implementations, the SA input 112-2 and/or features 114-2 may correspond to respective channels. The SA input 112-2 may comprise features 114-2A through 114-2Z configured to quantity EO radiation intensity at each of Z channels (e.g., at channels Ch_A through Ch_Z, as disclosed herein). By way of non-limiting example, the MLSA unit 120 may be configured to analyze SA input data 112-2 comprising 8196 channels (e.g., the SA input data 112-2 may comprise 8196 features 114-2). Alternatively, or in addition, the MLSA device 110 may be configured to extract and/or analyze features 114-2 corresponding to a graphical or image-based representation of the SA input 112-2 (e.g., a GSA 116-2). The features 114-2 may comprise and/or correspond to respective GSA features 117-2, as disclosed herein.

The gamma spectrum of the SA input 112-2 illustrated in FIG. 2B may be associated with any suitable subject 106 of radiation spectroscopy. The SA input 112-2 may comprise peaks at characteristic energies of respective radioisotopes. In the FIG. 2B example, the SA input 112-2 comprises peaks at characteristic energies E0 through E40, corresponding to Europium-154 (Eu-154), Cerium-134 (Ce-134), Ce-144, Antimony-125 (Sb-125), Rhodium-106 (Rh-106), Caesium-137 (Cs-137), Praseodymium-144 (Pr-144), Zirconium 95 (Zr-95), Niobium-95 (Nb-95), Silver-110m (Ag-110m), Cobalt-60 (Co-60), and Potassium-40 (K-40), as illustrated in Table 1 below:

TABLE 1

| Radioisotope | Characteristic energy (keV) |
|---|---|
| Eu-154 | 123.07 (E00), 248.0 (E03), 996.3 and 1004.8 (E23), |
| | 1274.54 (E33), 1596.5 (E38) |
| Ce-144 | 133.5 (E01) |
| Sb-125 | 176.3 (E02), 427.9 (E04), 463.4 (E05), 636.0 (E12) |
| Ce-134 | 475.3 (E06), 563.2 and 569.3 (E08), 604.7 (E09), 795.9 |
| | (E18), 801.9 (E19), 1038.6 (E24), 1167.94 (E28), |
| | 1365.1 (E31) |
| Rh-106 | 511.8 (E07), 616.2 (E10), 621.9 (E11), 873.5 (E20), |
| | 1050.4 (E25), 1062.2 (E26), 1128.0 (E27), 1194.7 |
| | (E29), 1265.4 (E30), 1562.2 (E37), 1766.3 (E39), |
| | 1796.8 (E40) |
| Cs-137 | 661.7 (E13) |
| Pr-144 | 696.5 (E14), 1489.1 (E36) |
| Zr-95 | 724.2 (E15), 756.7 (E16) |
| Nb-95 | 765.8 (E17) |
| Ag-110m | 844.7 (E21), 937.5 (E22), 1384.3 (E34) |
| Co-60 | 1332.5 (E32) |
| K-40 | 1460.8 (E35) |

Although examples of radioisotopes having specified characteristic energies are described herein, the disclosure is not limited in this regard and could be adapted for analysis of SA input data 112-2 corresponding to any suitable radioisotopes having any suitable characteristic radiation energies.

The RML module 140 may be configured to implement an RML CFG 150-2 configured to implement an SA application 130-2 pertaining to radioisotope spectroscopy. More specifically, the RML CFG 150-2 may be adapted to configure the RML module 140 (and/or Policy 142) to generate SA outputs 122-2 in response to gamma spectra (e.g., in response to features 114-2 of SA input data 112-2 comprising gamma spectra). As disclosed in further detail herein, the RML CFG 150-2 may be learned, developed, and/or refined in an RML procedure 160 involving a critic 144 (or other adversarial network). In the FIG. 2B example, the RML CFG 150-2 may be learned by training the MLSA unit 120 (and/or ML component(s) 140 thereof) to accurately identify and/or quantify characteristic emission(s) of respective radioisotopes of R RoI.

The RML CFG 150-2 may be adapted to configure the MLSA unit 120 to predict labels 134-2 defined for the radioisotope spectroscopy SA application 130-2, e.g., labels 134 representing respective RoI. As illustrated in FIG. 2B, the RML CFG 150-2 may configure the MLSA unit 120 to generate SA output data 122-2 comprising predictions 124-2-A through 124-1-T for labels 134-1-A through 126-1-T, respectively. The labels 134-1-A through 126-1-T may correspond to respective radioisotopes of R radioisotopes interest, e.g., may correspond to Eu-154, Ce-134, Ce-144, Sb-125, Rhodium-106, Cs-137, Pr-144, Zr-95, Nb-95, Ag-110m, Co-60, K-40, and so on.

The MLSA unit 120 may be configured to identify and/or quantify any suitable set of radioisotopes, e.g., R radioisotopes of interest where R is a positive integer. In some implementations, R is between 1 and 64. The complexity, computational overhead, and/or performance of the MLSA unit 120 may depend, at least in part, on R, e.g., complexity and computational overhead may increase with increasing values of R. Accordingly, in some implementations, the MLSA device 110 may be configured to identify and/or quantify a more limited set of RoI. For example, the RML module 140 may be configured to identify and/or quantify between about 32 and 38 radioisotopes of interest. The disclosure is not limited in this regard, however, and could be adapted for any suitable set of R RoI in accordance with complexity, computational overhead, performance, and/or other considerations.

The RML CFG 150-2 may be adapted to configure the RML module 140 (and/or Policy 142) to predict the presence (or absence) of respective radioisotopes, e.g., the predictions 124-2 may predict the presence (or absence) of labels 134-2, each label 134-2 representing a respective RoI. By way of non-limiting example, the SA output 122-2 generated by the MLSA device 110 may comprise prediction data 124-2-Ce_134 for a label 134-2-Ce_134 configured to represent Cerium-134 (Ce-134). More specifically, the label 134-2-Ce-134 may correspond to nuclear decay of Ce-134 at 475.3 (E06), 563.2 and 569.3 (E08), 604.7 (E09), 795.9 (E18), 801.9 (E19), 1038.6 (E24), 1167.94 (E28), and/or 1365.1 (E31) keV. The prediction data 124-2-Ce_134 generated by the MLSA unit 120 in response to the SA input 112-2 may indicate the presence (or absence) of characteristic radiation of Ce-134 within the gamma spectrum of the SA input data 112-2 and, hence, a probability that Ce-134 is present within the corresponding subject 106.

In some implementations, the RML module 140 may be configured to predict emission levels of respective RoI. Radioisotope emission level may be expressed in any suitable terms, such as curie (Ci), microcurie (μCi or μc), and/or the like. In a first non-limiting example, the RML CFG 150-2 may be adapted to configure the MLSA unit 120 to determine prediction data 124-2-Ce_134 for a plurality of “Ce-134” labels 134-2-Ce_134-1 through 126-Ce_134-D, each configured to represent a respective radiation emission level of characteristic radiation of Ce-134 within the gamma spectrum of the SA input 112-2 (e.g., each covering respective emission level(s) at the characteristic energies of Ce-134, such as E06, E08, E09, E18, E19, E24, E28, E31, and so on) and, hence, a respective quantity or concentration of Ce-134 within the subject 106. The prediction data 124-2-Ce-134 determined for the SA input 112-2 may indicate a probability that the gamma spectrum comprises characteristic radiation of Ce-134 at emission levels represented by the respective “Ce-134” labels 134-2-Ce_134-1 through 126-2-Ce_134-D. Thus, the prediction data 124-2-Ce_134 may indicate a probability that the subject 106 comprises Ce-134 in the quantities or concentrations represented by the respective “Ce-134” labels 134-2-Ce_134-1 through 126-2-Ce_134-D.

Alternatively, or in addition, the RML CFG 150-2 may be adapted to configure the RML module 140 to determine predictions 124-2 for labels 134-2 configured to quantity emission of respective radioisotopes of interest. In a second non-limiting example, the prediction data 124-2-Ce_134 and/or label 134-2-Ce_134 determined for the SA input 112-2 may be configured to quantify EO radiation within the gamma spectrum at the characteristic energy level(s) of Ce-134, which may indicate the quantity or concentration of Ce-134 within the subject 106, as disclosed herein (without the need to predict a plurality of “Ce-124” labels 134-2-Ce_134-1 through 126-2-Ce_134-D).

As disclosed herein, the RML module 140 disclosed enables improvements to practical applications of spectrum analysis by, inter alia, obviating the need for numerical, human-interactive techniques. The RML module 140 also enables improvements relative to regression-type and/or supervised ML techniques. The reinforcement machine learning implementations disclosed herein may be used to learn and/or refine policies 142 that are more accurate and less susceptible to variable noise conditions.

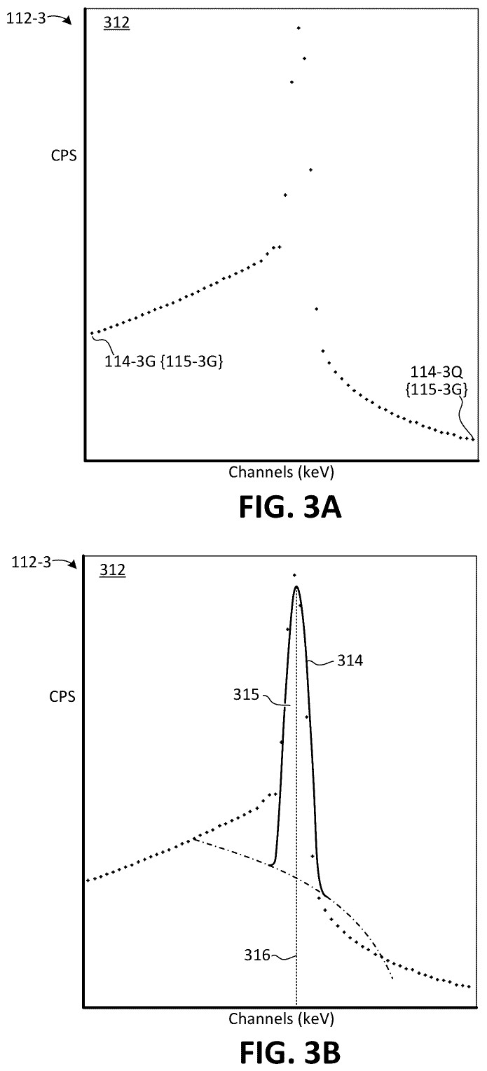

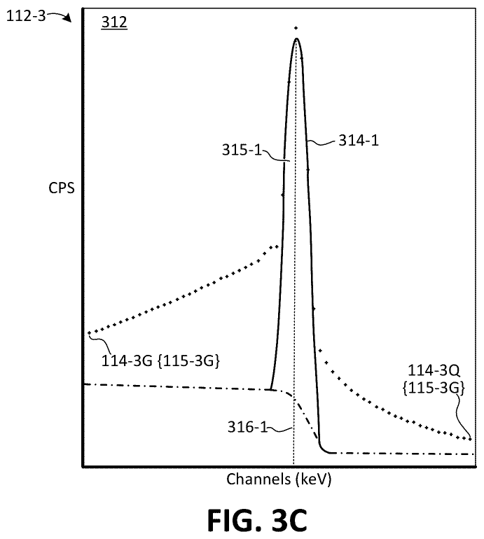

FIG. 3A illustrates a section 312 of the SA input data 112-3 that includes features 114-3G through 114-3Q (e.g., activity quantities 115-3G through 115-3Q corresponding to channels Ch_G through Ch_Q respectively). The SA input data 112-3 may comprise noise, background signal(s), a plurality of overlapping peaks, and/or the like, as disclosed herein. Therefore, although it may be possible to identify peaks through numerical or human-interactive analysis techniques (e.g., curve fitting), or supervised ML, these techniques can introduce uncertainty and lead to error. In a first example, a peak within the section 312 may be modeled by fitting features 114-3 to a mathematical model, such as a polynomial, spline, cubic spline, exponential, Gaussian function, and/or the like. As illustrated in FIG. 3B, the features 114-3 may be fit to a curve 314 centered at a determined peak energy 316. The area 315 under the curve 314 may correspond to emission at the determined peak energy 316. In a second example, the area 3154 under the curve 314 and/or resulting characteristic emission at the peak energy 316 may be estimated by a machine-learned model trained through regression-type, supervised ML, such as an MLP, ANN, CNN, or the like. These techniques, however, can become unreliable due to variable noise conditions, as disclosed herein, e.g., background noise, geometry changes, measurement rate (e.g., high or low count rate), multiple overlapping peaks (spectra comprising multiple radioisotopes), and so on. Although efforts have been made to improve the accuracy of numerical curve fitting techniques, even these improved approaches rarely obtain acceptable uncertainty (3% or less at 68% confidence) in even the most ideal conditions. For example, the uncertainty of the curve 314 illustrated in FIG. 3B may be about 9.07%. Although regression-type ML techniques can address some of these issues, the performance of these methods can be adversely impacted by variable noise conditions.

Although human intervention can improve the accuracy of numerical curve fitting and regression-type ML techniques, these approaches are not feasible in many applications and are subject to human bias and/or error. FIG. 3C illustrates an example of a curve 314-1 obtained through an interactive curve fitting procedure (a curve 314-1 at a peak energy of 316-1, corresponding to an activity or area 315-1). The uncertainty of the interactive fit may be about 2.77% (a reduction of 5.3% as compared to the automated fit example of FIG. 3B). However, even small curve fitting errors can lead to significant analysis inaccuracies. For example, as shown in FIG. 2B, the peak energies of some radioisotopes may be closely spaced, meaning that relatively small errors in peak energy (e.g., 316 or 316-1) may result in radioisotope misidentification. Similarly, relatively minor errors in the numerical model (in curve 314 or 314-1) may result in significant differences in detected emission level (error in area 315 or 315-1). Moreover, due to the need for expert human intervention, interactive analysis techniques may not be scalable. For example, interactive spectral analysis may take many days to complete even by highly trained personnel. Moreover, complicated spectra often must be re-analyzed; experts may examine initial spectrum analysis results and use their experience and expertise to draw conclusions about the presence and quantities of radioisotopes that may not be detected through conventional automated, or even interactive spectrum analysis.

Referring back to FIG. 1A, the RML module 140 of the MLSA device 110 may overcome these and other shortcomings of numerical and regression-type ML. For example, the MLSA device 110 illustrated in FIG. 1A may be configured to utilize a trained RML module 140 (e.g., trained policy 142) to analyze noisy, complex spectra with high accuracy and without the need for human intervention or re-analysis. The systems, methods, and devices disclosed herein, therefore, constitute improvements to SA technology. The MLSA unit 120 may be configured to identify and/or quantify activity at designated spectral locations, e.g., at characteristic EO radiation energy level(s), channels, frequencies, wavelengths, and/or the like. The practical applications of SA may include, but are not limited to optical SA applications, emission SA applications, radioisotope SA applications, and/or the like.

The RML module 140 may comprise and/or implement an Policy 142, which may be trained to implement an SA application 130 through, inter alia, an RML procedure 160. The RML procedure 160 may utilize spectra analysis data with both radioisotope identification and quantification to serve as training data. The RML procedure 160 may be configured to train against a wide array of experimental spectra collected over large timescales and incorporate changes in the experimental environment when executing inference without expert intervention.

In some implementations, the RML procedure 1060 comprises a Markov Decision Process (MDP) with a reward structure that includes positive and negative rewards during training, and then infers the spectra analysis when provided unknown spectra. The resulting graded reward structure with penalization ensures that the state space of the SA application 130 is searched to a high degree. As disclosed in further detail herein, the state space of the RML procedure 160 may comprise an N dimensional space configured to represent potential microcurie emission levels for respective radioisotopes of N RoI (e.g., from 0 μCi to 1E6 μCi for respective RoI). Accordingly, respective states of the state space may comprise predictions 124A-N for labels 134A-N determined based on an SA input 112 (spectrum data) of the SA application 130, as disclosed herein.

The training may utilize an actor/critic RML architecture in which an actor (policy 142) determines actions in respective time steps t. The actions may include raising or lowering the microcurie level predicted for respective RoI by 1E-2. In each time step, the actor (Policy 142) may determine an action based, at least in part, on a current observation of the current state or environment, e.g., the current set of predictions 124, the input spectrum data, and/or the like. The environment for training may comprise SA input data 112 with potentially varying environments (resulting in variable noise within the spectrum data). The SA input data 112 may comprise any suitable features 114, such as direct channel inputs (e.g., 8192 channel inputs), visual inputs (e.g., GSD features 117), and/or the like, as disclosed herein.

The policy 142 may comprise any suitable Al/ML component(s) 121. For example, the model by which the policy 142 converts states into actions may comprise a MLP (e.g., a three layer MLP network), an ANN, a CNN (e.g., a CNN comprising at least two layers), and/or the like.

The RML architecture 162 may further comprise a critic 144, which may be configured to evaluate actions of the actor in accordance with a learned reward structure or value function V. The reward structure may be graded for each time step t. By way of non-limiting example, the reward structure may assign: +10 for an radioisotope quantity prediction(s) 124 with 1% of the actual, +5 within 50%, +2 within 100%, −2 otherwise for each time and/or rollout step.

In some embodiments, the RML procedure 160 employs proximal policy optimization (PPO) with stochastic gradient descent (SGD) to perform a plurality of rollouts (or simulations of the policy) substantially in parallel. The RML procedure 160 may, therefore, be highly scalable across a plurality of processors (e.g., across hundreds of GPUs for training). The discount factor utilized in the RML procedure 160 may be far-sighted.

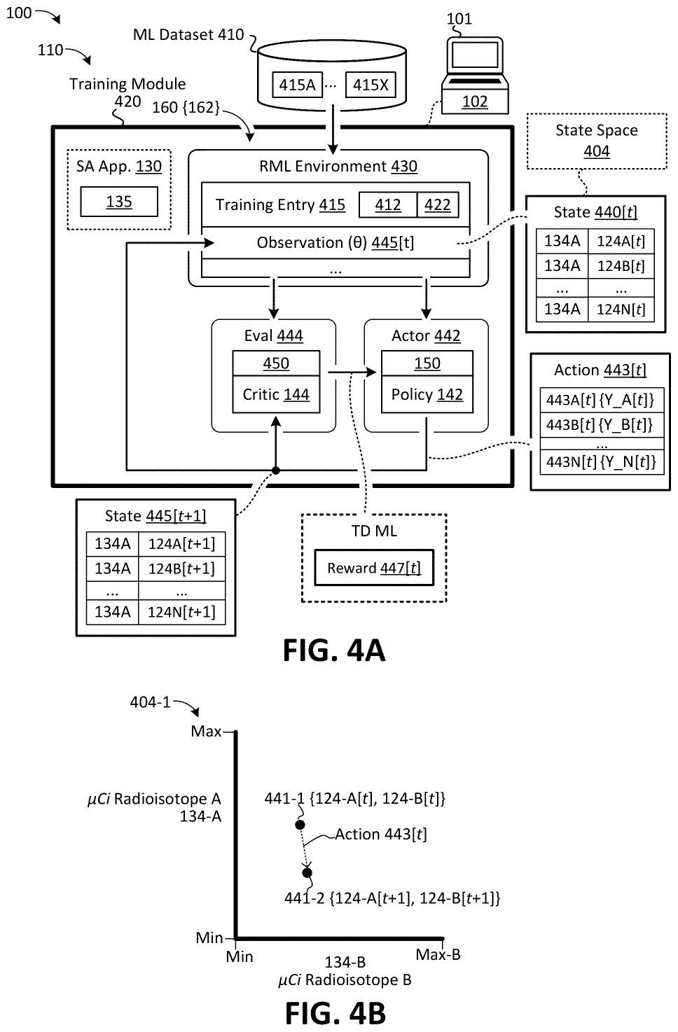

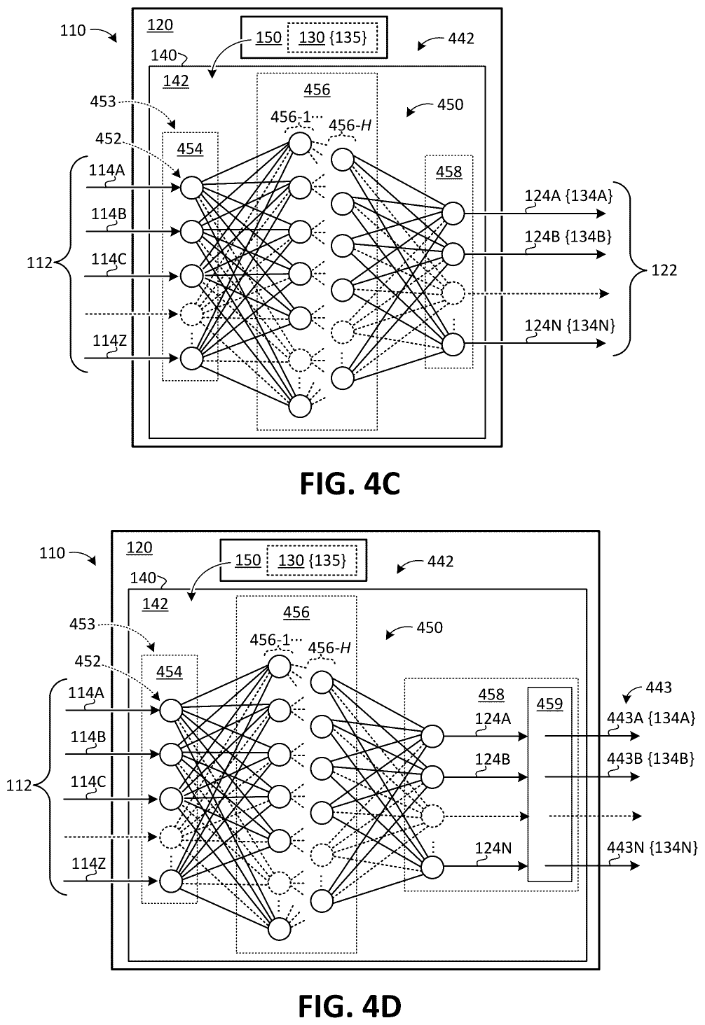

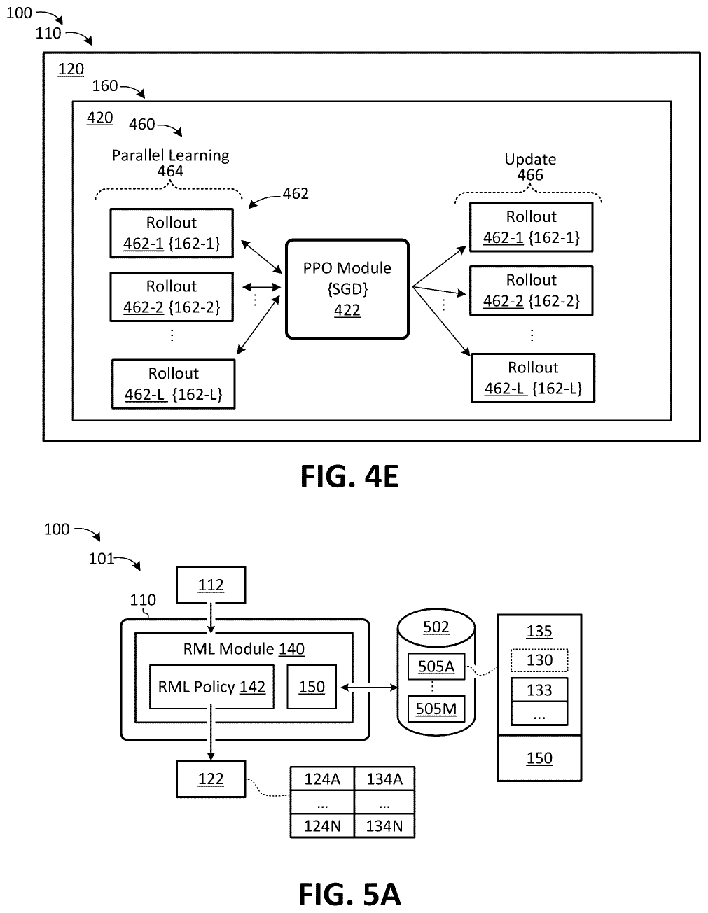

FIG. 4A is a schematic block diagram illustrating an example of an MLSA device 110 configured to implement aspects of an RML procedure 160, as disclosed herein. In the FIG. 4A example, the MLSA device 110 may comprise a training module 420. The training module 420 may be configured for execution on computing resources 102 of a computing device or apparatus 101, as disclosed herein.

The training module 420 may comprise and/or implement a suitable RML architecture 162. In the FIG. 4A example, the training module 420 may be configured to implement an actor/critic (AC) RML architecture 162, which may comprise, inter alia, ML components 121 suitable for AC RML techniques, such as an environment 430, actor 442, critic 444, and so on, as disclosed in further detail herein.

The training module 420 may be configured to learn a policy 142 for a target SA application 130 through implementation of an RML training procedure 160. Aspects of the SA application 130 may be defined by SAA metadata 135, as disclosed herein. The Training module 420 may configure the RML training procedure 160 in accordance with the SAA metadata 135, e.g., configure the RML training procedure 160 to learn a policy 142 configured to determine suitable predictions 124 for labels 134 of the SA application 130 (e.g., per a vocabulary of the SA application 130).

The RML procedure 160 may learn and/or refine the policy 142 by use of an ML dataset 410. The ML dataset 410 may comprise any information suitable for training, validating, testing, refining, and/or otherwise learning an policy 142 (and/or corresponding RML CFG data 150) through the RML procedure 160. The ML dataset 410 may comprise and/or embodied by any suitable computer-readable memory and/or storage resource, such as a datastore, database, network-accessible storage, NT storage resources 102-3, and/or the like.

In some implementations, the ML dataset 410 may comprise a plurality of entries 415 (or training entries 415), each comprising a respective ML input 412 and corresponding ML output 422. The ML entries 415 may be configured in accordance with the target SA application 130. The ML inputs 412 may comprise SA input data 112 to be analyzed in the target SA application 130 (e.g., emission spectra, gamma spectra, and/or the like). The ML outputs 422 may comprise known or predetermined SA output data 122 for respective ML inputs 412. In other words, the ML outputs 422 may comprise “ground truth” (GT) predictions 124 for respective labels 134 of the SA application 130 (e.g., may comprise known prediction values for respective labels 134A-N, respectively).

By way of non-limiting example, the ML inputs 412 may comprise gamma spectra having known or predetermined characteristics and the corresponding ML outputs 422 may comprise GT predictions 124 that accurately reflect the known or predetermined characteristics of the gamma spectra. By way of further non-limiting example, the ML outputs 422 may comprise GT predictions 124A-N configured to accurately predict the presence (or absence) of respective radioisotopes of R RoI. Alternatively, or in addition, the ML outputs 422 may comprise predictions 124A-N configured to quantify the emission level (e.g., μC emission), quantity, and/or concentration of respective radioisotopes.

In some implementations, entries 415 of the ML dataset 410 may be derived from previously determined (and/or verified) spectrum analysis operations. The ML dataset 410 may comprise one or more “real-world” or “raw” entries 415. As used herein, a “real-world” or “raw” entry 415 may refer to an entry 415 comprising spectrum data acquired by an acquisition device 104 and/or sensor 105 from a subject 106 and/or region 108, as disclosed herein (e.g., a “real-world” or “raw” ML input 412). For example, one or more of the ML entries 415 may comprise ML input data 412 comprising gamma spectra acquired from subjects 106 having known or predetermined radioisotope compositions, e.g., subjects 106 having known physical compositions or, in other words, subjects 106 comprising known or predetermined radioisotopes in known or predetermined quantities, concentrations, and/or physical configurations. The corresponding ML outputs 422 may comprise predictions 124 that accurately reflect the known or predetermined radioisotope compositions of the subjects 106, e.g., may accurately predict the presence, emission level, quantity, and/or concentration of respective radioisotopes of the R radioisotopes of interest.

Alternatively, or in addition, the ML dataset 410 may comprise one or more “synthetic” and/or “hybrid” entries 415. As used herein, a “synthetic” ML entry 415 may refer to an ML entry 415 comprising spectrum data acquired through simulation or other data generation process, e.g., “synthetic” spectrum data obtained and/or generated by means other than acquisition by an acquisition device 104 and/or sensor 105. For example, synthetic spectrum data may be generated by simulating the response of an acquisition device 104 and/or sensor 105 to specified stimuli, such a subject 106 having a specified radioisotope composition. As used herein, a “hybrid” ML entry 415 may refer to an ML entry 415 having an ML input 412 comprising raw spectrum data and one or more synthetic signals. For example, hybrid spectrum data may be generated by incorporating one or more synthetic noise signal(s) into acquired spectrum data, as disclosed in further detail herein.

The RML procedure 160 implemented by the training module 420 may involve an environment 430. The environment 430 may comprise and/or correspond to a state space 404. The state space 404 may be configured in accordance with the target SA application 130. More specifically, the state space 404 may be configured to comprise and/or represent respective labels 134 of the SA application 130 (e.g., may correspond to the vocabulary 133 of the target SA application 130 as defined by the SAA metadata 135). In the FIGS. 1A and 4A examples, the state space 404 may comprise an N-dimensional space, where N is the number of labels 134 to be predicted by the RML trained policy 142. The state space 404 may define a set of possible values (predictions 124) for respective labels 134. In other words, the state space 404 may define the bounds for the predictions 124 determined for respective labels 134. For example, the state space 404 may define a range of possible emission values for respective radioisotopes of R RoI, e.g., from a minimum value of about 0 μCi to a maximum value of about 1e6 μCi (or higher, depending on the target SA application 130). The state space 404 may, therefore, define a set of possible states 440, each state 440 comprising a respective set of predictions 124 for each label 134. For example, each state 440 may comprise a respective set of N predictions 124A-N for labels 134A-N, respectively.

FIG. 4B illustrates an example of a simplified 2-dimenstional state space 404-1 for an SA application 130. The state space 404-1 comprises two labels 134 configured to represent emission of radioisotope A (134-A) and radioisotope B (134-B), respectively, e.g., a two-dimensional space. As illustrated in FIG. 4B, points 441 within the state space 404 may define and/or correspond to respective states 440. The states 440 may correspond to predictions 124 for μCi emission of radioisotopes A and B (represented by labels 134-A and 134-B). For example, a first point 441-1 within the state space 404-1 may define predictions 124 corresponding to a time step t, including a first prediction 124-A[t] for the μCi emission of radioisotope A and a first prediction 124-B[t] for the μCi emission of radioisotope B.

As disclosed in further detail herein, the RML procedure 160 may comprise configuring the actor 442 (and/or policy 142) to determine actions 443, each action 443 configured to modify a previous or current state 440[t] corresponding to time step t to produce a next state 440[t+1]. An action 443 may comprise modifying one or more predictions 124 determined for respective labels 134. An action 443 may comprise modifying respective predictions 124 within specified bounds. For example, an action 443 may comprise raising or lowering the prediction 124 of a label 134 by an incremental delta value Y, where Y is about 1E-2, e.g., pᵢ[t+1]=pᵢ[t]+Yᵢ; Y_{Min}≤Yᵢ≤Y_{Max}, where pᵢ[t] is the prediction 124 for the ith label 134 in the current state 440[t] and Yᵢ is a value within the bounds defined by Y_{Min} and Y_{Max}, e.g., a value between −1E-2 μCi and 1E-2 μCi.

FIG. 4B further illustrates an example of an action 443, e.g., an action 443[t] determined at time step t. In the FIG. 4B example, the action 443[t] may comprise reducing the μCi prediction 124 for radioisotope A (from 124-A[t] down to 124-A[t+1]) and increasing the μCi prediction 124 for radioisotope B (from 124-B[t] up to 124-B[t+1]). In other examples, an action 443 may modify a subset of the predictions 124; for example, an action 443 may modify the prediction 124-A for label 134-A but may not modify the prediction 124-B for label 134-B, or vice versa. In some implementations, actions 443 may modify predictions 124 in fixed steps or increments, e.g., by ±Y_{Max}. Alternatively, actions 443 may be configured to modify predictions 124 by any of a continuous range of values, e.g., Y_{Min}≤Yᵢ≤Y_{Max}, as illustrated in the FIG. 4B example.

Referring back to FIG. 4A, the Training module 420 may be configured to process respective entries 415 of the ML training dataset 410. Processing an ML entry 415 may comprise configuring the actor 442 to determine actions 443 within an environment 430. The environment 430 may comprise and/or refer to a current observation (0) 445, which may comprise, inter alia, the ML input 412 (spectrum data being analyzed), the current state 440[t] comprising predictions 124 determined for the ML entry 415 by the actor 442, e.g., predictions 124A-N for respective labels 134A-N, and so on. The actor 442 may be configured to determine an action 443[t] for time step t based on the observation 445[t]. The action 443[t] may comprise modifying one or more of the predictions 124, as disclosed herein. In the FIG. 4A example, the action 443[t] may comprise determining actions 443A[t] through 443N[t] configured to modify the predictions 124A-N of labels 134A-N by Y_A[t] through Y_N[t], respectively. The actions 443[t] generated by the actor 442 at respective time steps t (per the policy 142) may determine the observation 445[t+1] at the next time step t+1, e.g., determine the state 440[t+1] for the next iteration t+1.

The actor 442 may be configured to determine actions 443 over a plurality of time steps t, e.g., over T time steps, where T is an iteration threshold for the RML procedure 160. The disclosure is not limited in this regard, however, and could be configured to iteratively process ML entries 415 over any suitable number of time steps and/or until other termination criteria are satisfied.

As disclosed herein, the actor 442 may determine actions 443 in response to respective observations 445 by use of the policy 142. The policy 142 may comprise any suitable ML component(s) 121. For example, the policy 142 may comprise a function approximator, such as an MLP, ANN, CNN, and/or the like. The policy 142 may be trained to produce the “best” action 443 for a given state 440. As disclosed in further detail herein, the “best” action 443 for a given state 440 may refer to the action 443 that results in the greatest reward and/or projected future reward as determined by the evaluator 444.

The evaluator 444 may quantity the utility of respective actions 443 using an adversarial network, such as a critic 144. The critic 144 may comprise a function approximator, such as an MLP, ANN, CNN, and/or the like. The critic 144 may be implemented in accordance with critic configuration data (critic CFG data 450 or a critic CFG 450). Like the RML CFG 150 learned for the policy 142, the critic CFG 450 may comprise any suitable information pertaining to the implementation and/or configuration of the critic 144. The critic CFG 450 may, for example, specify hyperparameters, weights, node interconnections, and/or other characteristics of the critic 144. The critic CFG 450 may, therefore, enable the MLSA module 120 to create one or more instances of the critic 144.

The critic 144 may be configured to receive inputs comprising the environment 430 and the action 443 determined by the actor 442 and, in response, determine a reward 447. As disclosed in further detail herein, the critic 144 may be configured to learn a value function V configured to quantify the utility or value of respective states 440 (and, by extension, the value of respective actions 443). The reward 447[t] assigned to an action 443[t] at time step t may be configured to quantify the utility or value of the action 443[t], which may be based, at least in part, on a comparison between the current state 440[t] and the state 440[t+1] resulting from the action 443[t], e.g., may be based on a comparison V(sₜ₊₁)−V(sₜ), where V is the current value function learned by the critic 144.

As illustrated in the FIG. 4A example, the reward 447[t] determined for time step t may quantify the utility of the action 443[t] taken by the actor 442 (policy 142) in response to state 440[t]. In some implementations, the critic 144 concatenates its inputs (the environment 430 and action 443 taken by the actor 442) and concatenates them within a reward 447 comprising a Q-value. In other words, the reward 447 may comprise a Q-value configured to estimate the maximum future reward associated with the environment 430 and action 443.

As disclosed herein, the actor 442 (policy 142) and critic 144 may comprise and/or be embodied by any suitable ML components 121. By way of non-limiting example, the policy 142 and critic 144 may comprise separate, independent MLP networks with ReLU activation. The policy 142 may comprise a 3-level MLP with linear layers constructed with layers with relative size ratios of 32, 18, and 8; in PyTorch pseudocode, the policy 142 may be constructed as follows actor_sequence=nn.Sequential of nn.Linear (SPECTRA_FEATURES, 32, ReLU), nn.Linear (32, 16, ReLU), nn.Linear (16, 8, ReLU), and nn.Linear (8, 1, nn.Identity), where SPECTRA_FEATURES is the number of features 114 included in respective SA inputs 112 (e.g., 8196). Using similar pseudocode, forward propagation of the policy 142 may be implemented by x=torch.squeeze (actor_sequence (x), −1). The critic 144 may comprise a separate three-level MLP with linear layers, which may be constructed from two sequences, wherein critic_sequence1 comprises nn.Linear (SPECTRA_FEATURES, 32, ReLU), nn.Linear (32, 16, ReLU), nn.Linear (16, 8, ReLU), and nn.Linear (8, 1, nn.Identity), and critic_sequence2 comprises nn.Linear (MAX_CHANNEL_SIZE, 64, ReLU), nn.Linear (64, 32, ReLU), nn.Linear (32, 8, ReLU), and nn.Linear (8, 1, nn.Identity), where MAX_CHANNEL_SIZE is a maximum size of respective channels of the SA inputs 112 (and/or a number of labels 134 predicted by the policy 142). Forward propagation of the critic 144 may be implemented by X=torch.squeeze (critic_sequence1(x), −1), torch.squeeze (critic_sequence2(x), −1). The combination of multiple MLP networks in the critic 144 may provide an expanded search space for the value function V learned by the critic 144 to generate the rewards 447 used by the actor 442 to learn the policy 142, as disclosed herein.

As illustrated above, the actor 442 (policy 142) and critic 144 may be configured to implement any suitable SA application 130 involving any suitable SA inputs 112 (e.g., any suitable MAX_CHANNEL_SIZE having any suitable number of SPECTRA_FEATYRES) and any suitable SA outputs 122 corresponding to any suitable vocabulary 133 and/or labels 134 (e.g., any suitably sized output layer). Although particular examples of an actor 442 (policy 142) and critic 144 are described herein, the disclosure is not limited in this regard and could be adapted to utility any suitable ML components 121. For example, the actor 442 (and/or policy 142) may be instantiated per the following pseudocode, where R_INTEREST is the number of RoI to be identified and/or quantified in the SA application 130:

```
SpectroscopyModel(
  (net): Sequential(
  (0): Linear(in_features= MAX_CHANNEL_SIZE,
  out_features=16384, bias=True)
  (1): Tanh( )
  (2): Linear(in_features=16384, out_features=8192, bias=True)
  (3): Tanh( )
  (4): Linear(in_features=8192, out_features=R_INTEREST,
  bias=True)
  (5): Softmax(dim=None)
  )
)
```

In another non-limiting example, the actor 442 (policy 142) may be implemented by an ANN, as illustrated in FIG. 4C. In the FIG. 4C example, the MLSA device 110 may be configured to implement an actor 442 (policy 142) comprising an ANN 450. The ANN 450 may comprise a plurality of interconnected nodes 452 (artificial neurons). The nodes 452 may be organized within respective layers 453, including an input layer 454, one or more hidden layers 456, and an output layer 458. The disclosure is not limited in this regard, however, and could be adapted to implement any suitable network architecture (e.g., such as an MLP network, as disclosed above).

Nodes 452 of the ANN 450 may be configured to implement any suitable activation function including, but not limited to: identity, binary step, logistic (or soft step), hyperbolic tangent (tanh), SoftPlus, ArcTan, Rectified Linear Unit (ReLU), parametric ReLU, Exponential Linear Unit (ELU), Sigmoid, SoftPlus, Gaussian, or the like. For example, nodes 452 of the ANN 450 may be configured to implement tanh activation, where

$$tanh ( x ) = \frac{{e}^{x} - {e}^{- x}}{{e}^{x} + {e}^{- x}} .$$

In some implementations, nodes 452 of the output layer 458 may be configured to implement a different activation function, such as identity activation (e.g., nn.Identity, as disclosed above).

The input layer 454 of the ANN 450 may be configured to receive gamma spectra (e.g., SA inputs 112 that comprise and/or correspond gamma spectra, as disclosed herein). Nodes 452 of the input layer 454 may be configured to extract and/or process respective features 114 of the SA input 112. In FIG. 4C example, the input layer 454 comprises Z nodes 452 corresponding to features 114-1 through 114-Z of SA input 112, respectively. For example, the SA input 112 may comprise and/or correspond to a gamma spectrum having 8196 channels and, as such, the input layer 454 may comprise 8196 nodes 452, each corresponding to a respective channel (and/or respective feature 114) of the SA input data 112. Alternatively, or in addition, the SA input 112 may comprise GSA data 116 (e.g., a graphical, image-based representation of the gamma spectrum) and the input layer 454 may comprise nodes 452 corresponding to respective GSA features 117 of a graphical, image-based representation of the spectrum data; e.g., respective pixels or the like.

The ANN 450 may comprise one or more hidden layers 456, including a first hidden layer 456-1. In some implementations, the ANN 450 may comprise a single hidden layer 456. Alternatively, the ANN 450 may comprise a plurality of hidden layers 456, e.g., hidden layers 456-1 through 426-H, as illustrated in FIG. 4B. The first hidden layer 456-1 may have a higher resolution or density than the input layer 454. In other words, the first hidden layer 456-1 may comprise a larger number of nodes 452 than the input layer 454. In some implementations, the resolution and/or density of the hidden layers 456 may be substantially the same. Alternatively, the resolution and/or density of the hidden layers 456 may vary, e.g., the first hidden layer 456-1 may include a different number of nodes 452 than hidden layer 456-H.

The output layer 458 may be configured to generate SA output data 122 in response to SA input data 112. The SA output data 122 may be generated by respective nodes 452 of the output layer 458. In the FIG. 4B example, the output layer 458 comprises N nodes 452, each configured to produce a prediction 124 for a respective label 134 (e.g., nodes 452 configured to produce predictions 124A-N for labels 134A-N, respectively).

In a first non-limiting example, the predictions 124 determined for respective labels 134 may be configured to indicate the presence (or absence) of respective radioisotopes of R RoI. In the first non-limiting example, the output layer 458 may comprise N nodes 452, where N=R.

In a second non-limiting example, the ANN 450 of the MLSA unit 120 may be configured to distinguish emission levels for each of the R RoI. In the second non-limiting example, the output layer 458 may comprise N nodes, where N=R×L (and L is the number of different emission levels of each radioisotope R the MLSA unit 120 is configured to predict). In other words, in the second non-limiting example the output layer 458 of the ANN 450 may comprise L times as many nodes 452 as the output layer 458 of the first non-limiting example. Alternatively, the ANN 450 may be configured to predict different numbers of emission levels for respective radioisotopes of the R radioisotopes of interest and, as such, the output layer 458 may comprise N nodes, where N=Σᵢ₌₁^{R}Lᵢ and Lᵢ is the number of emission levels the ANN 450 is configured to distinguish for respective radioisotopes i of the R radioisotopes of interest.

In a third non-limiting example, the ANN 450 of the MLSA unit 120 may be configured to predict emission levels for respective radioisotopes of the R RoI. In the third non-limiting example, the output layer 458 may comprise N nodes 452, where N=R, the N nodes 452 configured to generate predictions 124A-N, each configured to quantify emission of a respective one of the R radioisotopes of interest (e.g., quantify emission of a radioisotope represented by a respective one of labels 134A-N).

As disclosed herein, during the RML procedure 160 the actor 442 (policy 142) may be configured to determine actions 443 to incrementally modify the predictions 124 for respective labels 134 over a plurality of time steps T. Accordingly, during implementation of the RML procedure 160, the output layer 458 of the actor 442 (policy 142) may be configured to generate actions 443 as opposed to predictions 124. In some implementations, the output layer 458 of the actor 442 (and/or nodes 452 thereof) may be modified to produce actions 443 during training and predictions 124 otherwise. The actor 442 may be configured to output probabilities for respective actions 443 (e.g., probabilities for respective labels 134). The probabilities may form a distribution and the action 443 may be chosen by sampling from this distribution.

Alternatively, or in addition, the actor 442 may include an additional training layer 459, which may be configured to convert predictions 124 determined for respective labels 134 into actions 443 for the respective labels, as illustrated in FIG. 4D. For example, the training layer 459 may be configured to produce actions 443 for respective labels based on a difference between the predictions 124 determined for the labels 134 in respective time steps t; the action 443 determined for the ith label 134i in response to state 440[t] may be based on a delta value Δᵢ, as follows Δᵢ=Pᵢ[t+1]−Pᵢ[t], where Pᵢ[t] is the prediction 124 in the previous or current state 440[t], and Pᵢ[t+1] is the prediction 124 determined by the policy 142 in response to the current state 440[t]. The actions 443 may be limited to values within predefined bounds, e.g., Y_{Min}≤Yᵢ≤Y_{Max} as disclosed herein.

In some implementations, the critic 144 may also be implemented by ML components 121 similar to the ANN 450 illustrated in FIGS. 4C and 4D. Alternatively, the critic 144 may be implemented using different type(s) of ML components 121, such as an MLP, as disclosed above.

Referring back to FIG. 4A, the critic 144 may also receive the state 440[t] as input and, in response, generate an output representing the estimated value of that state (per the GT predictions 124 associated with the ML output 422 of the entry 415). In some implementations, the critic 144 may determine a TD error for respective actions 443, which may quantify a difference or error between the value of the previous or current state 440[t] to the value of the next state 440[t+1] as follows, δₜ=rₜ₊₁+γV(sₜ₊₁)−V(sₜ), where δₜ is the TD error for time step t and V is the current value function learned by the critic 144. In other words, the critic 144 may be configured to learn a value function V to accurately assess the actions 443 (and/or predictions 124) produced by the policy 142. As disclosed in further detail herein, learning the value function V may constitute learning characteristics of noise signal(s) within the spectrum data of the ML inputs 412.

The actor 442 (policy 142) and critic 144 may be trained separately using any suitable technique, e.g., gradient descent, stochastic gradient descent (SGD), and/or the like. The training of the critic 144 may incorporate the known ML outputs 422 associated with the training spectrum data and, as such, may learn the value function V through supervised learning techniques. By contrast, techniques by which the actor 442 learns the policy 142 may be unsupervised in that they may rely on rewards 465 produced by the critic 144 as opposed to “supervised” data, such as GT predictions 124.

In some embodiments, the RML procedure 160 may be implemented as MDP having a graded reward structure. In other words, the critic 144 may be configured to generate rewards 465 adapted to a) penalize incorrect radioisotope identification and/or quantification and b) reward correct radioisotope identification and/or quantification in a graded fashion. The graded reward structure may be configured to ensure that the state space 404 is searched to a high degree.

As disclosed herein, the RML procedure 160 may comprise processing ML inputs 412 in an iterative, step-wise manner. At each iteration or time step t, the agent 442 may observe the state 440[t] of the environment 430 and determine an action 443[t]. The action 443[t] may be inferred based on the policy 142 and state 440[t] e.g., π(u|s), where π represents the policy 142, u represents the action 443[t] and s represents the state 440[t] of the environment 430. The action 443[t] may comprise setting predicted emission values 824 for each of the R RoI. More specifically, the action 443[t] may comprise, for each label 134, either a) increasing the prediction 124 of the μCi emission value of the corresponding radioisotope by a determined quantity Y (e.g., 1E−2 μCi), b) decreasing the predicted emission value 824 by Y, or c) maintaining the prediction 124 for the μCi emission value unchanged.

In response to the action 443[t], the environment 430 may produce a next state 440[t+1] and the critic 144 may determine a reward 447[t]. The reward 447[t] may be negative for actions 443[t] that result in incorrect radioisotope identification and/or quantification and positive for correct radioisotope identification and/or quantification. The rewards 465 may be determined in a graded manner, as disclosed herein. By way of non-limiting example, the critic 144 may be configured to apply a +10 reward 447 for a prediction 124 of a radioisotope quantity that is within 1% of the corresponding GT emission value, +5 within 50%, +2 within 100%, or −2 otherwise for each rollout or time step t. After a trajectory (T) of time steps t, the agent 442 may adjust the policy 142 based on the total rewards 465 received.

In some implementations, the agent 465 may be configured to directly learn the policy 142 via a three-level MLP network, as disclosed herein. The RML procedure 160 may comprise proximal policy optimization (PPO) with gradient descent, such as stochastic gradient descent (SGD) or the like.

In some embodiments, the RML procedure 160 may be implemented as illustrated in the following pseudocode (based on Python using PyTorch):

```
class ChainEnv(gym.Env):
    def_{——}init_{——}(self, env_config = None):
    env_config = env_config or { }
    self.n = env_config.get(″n″, 20)
    #payout for ‘backwards' action
    self.small_reward = env_config.get(″small″, 2)
    #payout at end of chain for ′forwards′ action
    self.large_reward = env_config.get(″large″, 10)
    #start at beginning of chain
    self.state = 0
    self._horizon = self.n
    #for terimating the episode
    self._counter = 0
    self._setup_spaces( )
  def_setup_spaces(self):
    ##############
    self.action_space = spaces.Discrete(2)
    self.observation_space = spaces.Discrete(self.n)
    ##############
  def step(self, action):
    assert self.action_space.contains(action)
    # ′backwards′: go back to the beginning, get small reward
    if action == 1:
      ##############
      reward = self.small_reward
      ##############
      self.state = 0
    # ′forwards′: go up along the chain
    elif self.state < self.n − 1:
      ##############
      reward = 0
      self.state += 1
    # ′forwards′: stay at the end of the chain, collect large reward
  else:
      ##############
      reward = self.large_reward
      ##############
    self._counter += 1
    done = self._counter >= self._horizon
    return self.state, reward, done, { }
  def reset(self):
    self.state = 0
    self._counter = 0
    return self.state
# Examples/Tests
test_exercises.test_chain_env_spaces(ChainEnv)
test_exercises.test_chain_env_reward(ChainEnv)
trainer_config = DEFAULT_CONFIG.copy( )
trainer_config[′num_workers′] = 1
trainer_config[″train_batch_size″] = 400
trainer_config[″sgd_minibatch_size″] = 64
trainer_config[″num_sgd_iter″] = 10
trainer = PPOTrainer(trainer_config, ChainEnv);
for i in range(20):
  print(″Training iteration { }...″.format(i))
  trainer.train( )
env = ChainEnv({ })
state = env.reset( )
done = False
max_state = −1
cumulative_reward = 0
while not done:
  action = trainer.compute_action(state)
  state, reward, done, results = env.step(action)
  max_state = max(max_state, state)
  cumulative_reward += reward
```

In some implementations, the training module 420 may be configured to implement a plurality of RML procedures 160 in parallel. FIG. 4E is a schematic block diagram of another example of an MLSA device 110 configured to implement aspects of an RML procedure 160. In the FIG. 4E example, the training engine 420 may be configured to implement a distributed and/or parallel RML (P RML) procedure 460. The P RML procedure 460 may be implemented in accordance with proximal policy optimization (PPO) logic 422. The PPO logic 422 may be configured to implement any suitable PPO algorithm, such as gradient descent, SGD, and/or the like.

The P RML procedure 422 may comprise a parallel learning phase 464 and an update phase 466. The parallel learning phase 464 may comprise implementing aspects of the RML procedure 160 on a plurality of “rollouts” 462, each rollout 462 comprising a respective RML architecture 162, as illustrated in FIG. 4A, e.g., rollouts 462-1 through 462-L may comprise RML architectures 162-1 through 162-L, respectively. In some embodiments, the training module 420 may implement L rollouts 462-1 through 462-L substantially in parallel; the rollouts 462 may comprise and/or be implemented on respective instances of the RML architecture 162, each comprising a respective environment 430, actor 442 (policy 142), evaluator 444 (critic 144), and so on. Each rollout 462 may, therefore, comprise a respective simulation of the policy 142 being learned through the RML procedure 160. The parallel learning phase 462 may comprise processing one or more entries 415 of the training dataset 410 in respective rollouts 462, each entry 415 processed over T time steps, as disclosed herein. The parallel learning phases 464 may comprise learning and/or refining the policy 142 and/or critic 144 (e.g., may comprise learning and/or refining RML CFG data 150, critic CFG data 450, and so on, as disclosed herein).

The update phase 466 may comprise broadcasting updates to the policy 142 and/or critic 144 to the rollouts 462. The updates may be determined and/or managed by the PPO module 422. For example, the PPO module 422 may be configured to combine multiples sets of updates determined by respective rollouts 462 during the parallel learning phase 464 into a single set of updates. The updates may be determined in accordance with a policy optimization algorithm, such as SGD. The actor 442 (policy 142) and evaluator 444 (critic 144) may be synchronized across respective parallel learning phase 464.

As disclosed herein, the policy 142 learned through the RML procedure 160 may be embodied in RML CFG data 150. As disclosed herein, the RML CFG data 150 may comprise any suitable information pertaining to implementation of the policy 142, such as an architecture of the ML components 121 comprising the policy 142, hyperparameters, node weights, node interconnections, and/or the like. The RML CFG data 150 learned through the RML procedure 160 may, therefore, enable the MLSA unit 120 to configure the RML module 140 to implement the target SA application 130 of the RML procedure 160, which may comprise instantiating the policy 142 and configuring the policy 142 to generate SA outputs 122 (e.g., predictions 124 for respective labels 134) in response to SA inputs 112 (e.g., spectrum data).

FIG. 5A is a schematic block diagram of a system 100 comprising another example of an MLSA device 110. The RML module 140 of the MLSA device 110 may be configured in accordance with the RML CFG 150 of the MLSA unit 120. As disclosed herein, the RML CFG 150 may be configured to cause the MLSA unit 120 to implement an SA application 130. In the FIG. 5A example, the RML CFG 150 may be adapted to cause the RML module 140 to implement a radiation spectroscopy SA application 130, e.g., may configure the policy 142 to generate predictions 124A-N for respective labels 134A-N of the SA application 130 in response to SA inputs 112 comprising radiation spectra.

The RML CFG 150 may be learned, developed, and/or refined an RML procedure 160, as disclosed herein. The RML CFG 150 may be adapted for any suitable type(s) of ML component(s) 121. In the FIG. 5A example, the RML CFG 150 may comprise information (e.g., hyperparameters) pertaining to implementation of an ANN 450, which may include, but are not limited to: the architecture of the ANN 450, the architecture of respective sub-components of the ANN 450 (e.g., define the types of nodes 452 and/or layers 453 implemented by the ANN 450, such as convolutional layers, linear layers, and/or the like), the configuration of respective layers 453 of the ANN 450 (e.g., specify a configuration of the input layer 454, one or more hidden layer(s) 426, the output layer 458, and so on), the number of nodes 452 included in respective layers 453 of the ANN 450, interconnections between nodes 452 and/or layers 453 of the ANN 450 (e.g., fully connected, non-fully connected, sparsely connected, or the like), the configuration for respective nodes 452 of the ANN 450 (e.g., specify activation functions for nodes 452 of respective layers 453), AI/ML parameters learned for respective nodes 452 (e.g., activation function weights, interconnection parameters, and/or the like), and so on.

The overhead involved in learning, developing, and/or refining an RML CFG 150 for an SA application 130 may be significant. Therefore, in some implementations, the MLSA unit 120 may be configured to implement a predetermined RML CFG 150. For example, the MLSA unit 120 may be configured to implement a predetermined RML CFG 150 learned in one or more previously completed RML procedures 160. The ML procedures may be implemented by the MLSA device 110 itself (and/or MLSA unit 120). Alternatively, one or more of the RML procedures 160 may be completed a different system or device, e.g., a different AI/ML system, a different MLSA device 110, a different MLSA unit 120, and/or the like.

The MLSA device 110 may utilize predetermined RML CFG 150 to avoid the complexity and overhead involved in developing RML CFG 150 for respective SA applications 130. By way of non-limiting example, a first RML CFG 150 for a first SA application 130 may be developed through RML procedures 160 completed on (or by) a first MLSA device 110. The first RML CFG 150 may then be used to configure other MLSA devices 110 to implement the first SA application 130. For instance, a second MLSA device 110 may leverage the first RML CFG 150 to implement the first SA application 130 without incurring the overhead involved in “relearning” a suitable RML CFG 150 for the first SA application 130, e.g., without repeating the RML procedure(s) 160 by which the first RML CFG 150 was learned.

Utilizing a predetermined RML CFG 150 to configure an MLSA device 110 to implement a target SA application 130 may comprise a) retrieving a predetermined RML CFG 150 for the target SA application 130, b) configuring an MLSA unit 120 of the MLSA device 110 in accordance with the predetermined RML CFG 150, and c) implementing the target SA application 130 by use of the MLSA unit 120.

The predetermined RML CFG 150 for the target SA application 130 may be retrieved through any suitable means including, but not limited to: a memory, memory resources 102-2 of the apparatus 101, computer-readable storage, non-transitory storage, NT storage resources 102-3 of the apparatus 101, network-accessible storage, a data interface 102-5 of the apparatus 101, HMI resources 102-4 of the apparatus 102-4, and/or the like. In some examples, the predetermined RML CFG 150 may be retrieved from a data source, such as the data store 502 illustrated in FIG. 5A. The data store 502 may comprise any suitable means for the storage and/or retrieval computer-readable information including, but not limited to: a memory, memory resources 102-2, computer-readable storage, non-transitory storage, NT storage resources 102-3, network-accessible storage, a database, a data management system, a database management system, a library, a file system, and/or the like. The data store 502 may comprise RML CFG 150 configured for implementation of respective SA applications 130 (e.g., may comprise predetermined or pre-learned RML CFG 150, as disclosed herein). For example, the data store 502 may comprise ML CFG entries 505, each comprising a respective RML CFG 150 for a respective SA application 130 (e.g., M entries 505A-M comprising respective RML CFG 150A-M). In some implementations, the AI/ML entries 405 may further comprise SA metadata 135 (e.g., SA metadata 425A-M). The SA metadata 135 associated with an RML CFG 150 may comprise information pertaining to, inter alia, the SA application 130 of the RML CFG 150, such as an identifier of the SA application 130 (e.g., a name, tag, description, or other identifying information), characteristics of SA input data 112 of the SA application 130, characteristics of the SA output data 122 (e.g., a vocabulary 133 such as the labels 134 to be predicted in the SA application 130), and so on.

RML CFG 150 suitable for respective SA applications 130 may be retrieved from the data store 502 through any suitable means (e.g., through a search, selection, query, lookup, request, application programming interface (API), and/or the like). By way of non-limiting example, an RML CFG 150 for a particular SA application 130 may be retrieved through a search or query of the data store 400 (e.g., a search or query for an AI/ML entry 505, RML CFG 150 and/or SA metadata 135 associated with the particular SA application 130). By way of further non-limiting example, an RML CFG 150 for a particular SA application 130 may be selected a plurality of RML CFG 150A-M by, inter alia, comparing an identifier of the particular SA application 130 to SA metadata 135 of respective RML CFG 150 of the plurality of RML CFG 150A-M.

Configuring an MLSA unit 120 in accordance with the retrieved, predetermined RML CFG 150 may comprise instantiating and/or configuring ML component(s) 121 of the MLSA unit 120 in accordance with the predetermined RML CFG 150. In the example illustrated in FIG. 5A, configuring the MLSA unit 120 may comprise instantiating an policy 142 per the RML CFG 150. The policy 142 may comprise an MLP, ANN, CNN, and/or the like. In the FIG. 5A example, the policy 142 may comprise an ANN 450 comprising nodes 452 that are interconnected and/or organized within respective layers 453 as specified by the predetermined RML CFG 150. The instantiating may further comprise applying learned ML configuration data, such as learned weights, biases, and/or other parameters learned for respective nodes 452, learned parameters pertaining to interconnections between nodes 452 and/or layers 453 (e.g., adding or removing interconnections between nodes 452 and/or layers 453), and so on. Configuring the MLSA unit 120 in accordance with the predetermined RML CFG 150 may, therefore, comprise applying parameters learned through one or more previously completed RML procedures 160.

The MLSA unit 120 configured in accordance with the predetermined RML CFG 150 may be used to implement the SA application 130. Implementing the SA application 130 by use of the MLSA unit 120 may include: a) receiving SA input data 112, b) extracting and/or providing features 114 of the SA input data 112 to the MLSA unit 120 (e.g., providing features to respective nodes 452 of the input layer 454 of the ANN 450), and c) configuring the policy 142 to generate SA output data 122 comprising predictions 124 for respective labels 134 of the vocabulary 133 of the SA application 130 (e.g., as defined by the RML CFG 150).

In some implementations, the RML 1012 CFG 150 may be learned by use of a software or software-based components, such as a software-based training module 420, RML procedure 160, MLSA device 110, MLSA unit 120, ML components 121, and/or the like. As used herein, a software or software-based component may refer to a component that is implemented and/or embodied by computer-readable instructions configured for execution by a processor. For example, a software-based component may comprise one or more software modules stored within NT storage resources 102-3 of the apparatus 101-1, the software modules comprising instructions configured for execution by processing resources 102-1 of the apparatus 101-1.

An RML CFG 150 learned using software-based components may be used to implement MLSA devices 110 comprising other types of components. For example, an RML CFG 150 learned by use of the software components may be used in a hardware or hardware-based implementation. More specifically, the RML CFG 150 learned by use of a software-based training module 420 (and/or RML procedure 160) may be encoded into the firmware, design, and/or implementation of one or more hardware components of a hardware-based MLSA unit 120.

FIG. 5B illustrates an example of a system 100 comprising an apparatus 101 configured to implement aspects of MLSA, as disclosed herein. The apparatus 101 may comprise an electronic device comprising computing resources 102. The apparatus 101 may comprise, for example, a portable electronic device, such as a portable analysis device, portable scanning device, a radioisotope identification device (RIID), or the like.

The apparatus 101 may include a hardware-based MLSA unit 520 comprising one or more hardware-based ML component(s) 521, e.g., a hardware RML module 540. The hardware-based MLSA unit 520 may be configured to implement a target SA application 130. A predetermined RML CFG 150 learned for the target SA application 130 may be incorporated into the firmware, design, and/or implementation of the hardware components of the hardware-based MLSA module 540 and/or ML component(s) 521. For example, the RML CFG 150 may be incorporated into the design of a hardware policy 521, e.g., a hardware MLP, ANN, CNN, and/or the like.

The apparatus 101 may further comprise and/or be coupled to an acquisition device 104. The acquisition device 104 may be configured to acquire SA input data 112 for processing by the hardware-based MLSA module 520. Alternatively, or in addition, the hardware-based MLSA module 520 may be configured to retrieve SA input data 112 by use of computing resources 102 of the MLSA device 110, as disclosed herein.

The MLSA device 110 may be configured generate SA output data 122 in response to SA input data 112. The MLSA device 110 may be further configured to display a graphical representation of the SA output data 122 on HMI resources 102-4 of the apparatus 101, such as a display screen or the like. Alternatively, or in addition, the MLSA device 110 can record the SA output data 122 in memory resources 102-2 and/or NT storage resources 102-3, transmit the spectrum analysis data 122 on a network (by use of the data interface 102-5), and/or the like.

The RML procedures 160 disclosed herein may be capable of learning policies 142 that are capable of accurately implementing SA applications 130 in the presence of variable noise. The disclosed policy 142 (and RML procedure 160) may, therefore, enable improvements to practical applications of spectrum analysis, such as emission analysis, radiation spectroscopy, and/or the like.

The performance of the RML policy 142 in environments comprising variable noise may be predicated on training data comprising such noise. In some implementations, the MLSA device 110 may be further configured to generate training data that comprises noise likely to be encountered during real-world operation.

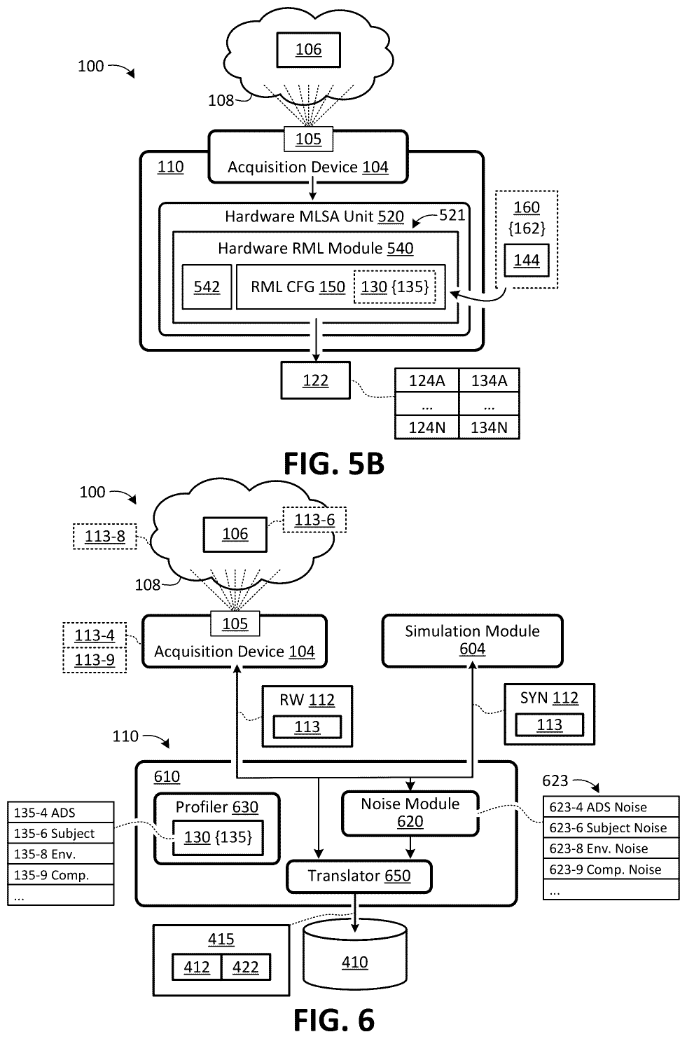

FIG. 6 is a schematic block diagram of an example of a system 100 comprising an MLSA device 110 configured to generate training data. In the FIG. 6 example, the MLSA device 110 may comprise a training data module 610. The MLSA device 110 may comprise other components, as disclosed herein, such as an MLSA module 120, RML module 140, training module 420, and so on (not depicted in FIG. 6 to avoid obscuring details of the illustrated examples).

The training data module 610 may be configured to generate entries 415 for the training dataset 410. As disclosed herein, an entry 415 of the training dataset 410 may comprise an ML input 412 and ML output 422. The ML input 412 may comprise SA input data 112 for a target SA application 130, e.g., spectrum data. The ML output 422 may comprise known prediction values for the ML input 412, e.g., may comprise GT predictions 124 or the like.

Generating an entry 415 for the training dataset 410 may comprise acquiring spectrum data for the entry 415 (SA input data 112) and determining corresponding GT predictions 124. For example, acquiring an entry 415 for a radioisotope spectroscopy SA application 130 may comprise acquiring SA input 112 from a subject 106 having a known radioisotope composition and assigning GT predictions 124 to the resulting entry 415 specifying known emission values for respective radioisotopes of the RoI of the SA application 130.

The training data module 610 may be configured to generate entries 415 from actual, real-world (RW) SA input data 112. As used herein, RW spectrum data refers to data captured from a subject 106 and/or region 108 by an acquisition device 104 and/or sensor 105. RW SA input data 112 may comprise and/or be associated with SA metadata 113. As disclosed herein, the SA metadata 113 may comprise information pertaining to acquisition of the RW SA input data 112. The SA metadata 113 may, therefore, indicate the types of noise signal(s) that may be present within the RW SA input data 112. The SA metadata 113 may comprise information pertaining to any aspect and/or characteristic pertaining to acquisition of the RW spectrum data, which may include, but is not limited to one or more of: acquisition device and/or sensor (ADS) SA metadata 113-4, subject SA metadata 113-6, environmental or region SA metadata 113-8, component SA metadata 113-9, and so on.

ADS SA metadata 113-4 may comprise information pertaining to the acquisition device 104 and/or sensor(s) 105 used to acquire the RW SA input data 112, which may include, but is not limited to information indicating: the type of acquisition device 104 and/or sensor 105 used to acquire the spectrum data, the configuration of the acquisition device 104 and/or sensor 105, settings of the acquisition device 104 and/or sensor 105, an operating mode of the acquisition device 104 and/or sensor 105 (e.g., pulse mode, current mode, or the like), and/or the like.

Subject SA metadata 113-6 may comprise information pertaining to the subject 106 of the spectrum data and may include, but is not limited to: characteristics of the subject 106, if known (e.g., a composition of the subject 106, the presence, concentration, and/or quantity of respective EoI of an emission SA application 130, the presence, concentration, and/or quantity of respective RoI of a radioisotope spectroscopy SA application 130, and/or the like), an orientation of the subject relative to the acquisition device 104 and/or sensor 105 (e.g., a distance, angle, offset, or the like), and so on.

Environmental or region SA metadata 113-8 may comprise information pertaining to environmental conditions under which the spectrum data were acquired, e.g., conditions within the acquisition region 108, which may include, but are not limited to: a temperature within the region 108, air pressure, characteristics of background radiation within the region 108, electromagnetic field(s) within the region 108, and so on.

Component SA metadata 113-9 may comprise information pertaining to components of the acquisition device 104, sensor 105, and/or other external devices that may introduce noise into the RW SA input data 112. For example, the component SA metadata 113-9 may indicate that the acquisition device 104 comprises a thermocouple component that can produce noise under certain circumstances, may indicate that the spectrum data 112 was acquired near external devices known to produce electromagnetic noise, such as fluorescent lighting, communications equipment, and/or the like, and so on.

Although, in the FIG. 6 example, the training data module 610 is configured to acquire RW SA input data 112 from an acquisition device 104, the disclosure is not limited in this regard. For example, the training data module 610 could be configured to retrieve RW SA input data 112 from a computer-readable storage resource, such as a datastore, NT storage resources 102-3, and/or the like.

Alternatively, or in addition, the training data module 610 may be configured to acquire synthetic (SYN) SA input data 112. As used herein, SYN spectrum data (and/or a SYN SA input 112) refers to spectrum data acquired by means other than an acquisition device 104 and/or sensor 105. SYN SA input data 112 may be acquired by use of a simulation module 604, as illustrated in the FIG. 6 example. The simulation module 604 may be configured to simulate the response of an acquisition device 104 and/or sensor 105 to specified stimuli, such as a subject 106 having a specified composition. The simulation module 604 may comprise and/or be coupled to any suitable simulation components, which may include, but are not limited to: a Monte Carlo N-Particle (MCNP) simulator (e.g., a simulator implemented by use of MCNP code), a Geant4 simulator, and/or the like. The simulation module 604 may be configured to simulate the response of specified types of acquisition devices 104 and/or sensors 105 to subjects 106 within environments or regions 108 having specified characteristics. Accordingly, SYN SA input data 112 may comprise and/or be associated with SA metadata 113 comprising ADS SA metadata 113-4, subject SA metadata 113-6, environmental SA metadata 113-8, component SA metadata 113-9, and so on. In some implementations, aspects of the SA metadata 113 may be used as inputs to configure generation of the SYN spectrum data by the simulation module 604. For example, the training data module 610 may configure the simulation module 604 to produce SYN spectrum data configured to simulate the response of a specified type of acquisition device 104 and/or sensor 105 (per ADS SA metadata 113-4) to a subject 106 having a specified composition (per subject SA metadata 113-6) captured under specified environmental conditions (per specified environmental SA metadata 113-8).

In some implementations, the training module 610 may be configured to generate entries 415 by acquiring first spectrum data, the first spectrum data comprising RW SA input data 112 or SYN SA input data 112 and determining known prediction values for the first spectrum data based, at least in part, on subject SA metadata 113-6 of the first spectrum data. The known prediction values may be assigned by a translator 650, which may be configured to map and/or translate subject SA metadata 113-6 to prediction values for respective labels 134 of the SA application 130. For example, the translator 650 may be configured to map SA metadata 113-6 indicating the quantity of respective RoI of interest within the subject of an SA input 112 to μCi emission values for respective RoI within the spectrum data of the SA input 112.

The training data module 610 may be configured to generate RW entries 415, e.g., entries 415 having ML inputs 412 comprising RW spectrum data. Generating an RW entry 415 may comprise configuring the acquisition device 104 to capture RW SA input data 112 from a subject 106 having a known composition, determining an ML output 422 for the entry 415 based on the known composition of the subject 106 (e.g., assigning GT predictions 124 to respective labels 134 of the SA application 130), and recording the resulting entry 415 in the ML dataset 410.

The training module 610 may be further configured to generate SYN entries 415, e.g., entries having ML inputs 412 comprising SYN spectrum data. Generating a SYN entry 415 may comprise configuring the simulation module 604 to generate first spectrum data, the first spectrum data configured to simulate the response to a specified type of acquisition device 104 and/or sensor 105 to a subject 106 having a specified composition, determine an ML output for the entry 415 based on the specified composition of the subject 106, and storing the resulting entry 415 in the ML dataset 410.

In some implementations, the training data module 610 may be further configured to generate hybrid entries 415 comprising spectrum data derived from RW spectrum data and/or SYN spectrum data. Generating a hybrid entry 415 may comprise acquiring first spectrum data and deriving second spectrum data from the first spectrum data, the deriving comprising combining the first spectrum data with one or more noise signal(s). Generating a hybrid entry 415 from RW spectrum data may comprise a) acquiring RW SA input data 112 pertaining to a subject 106 having known characteristics, and b) combining the acquired RW SA input data 112 with one or more noise signals. Generating a hybrid entry 415 from SYN spectrum data may comprise a) acquiring SYN SA input data 112 pertaining to a subject 106 having known characteristics and b) combining the acquired SYN input data 112 with one or more noise signal(s).

In some implementations, the noise signal(s) may be generated by a noise module 620. The noise module 620 may comprise model(s) 623 configured to model and/or characterize any suitable potential source of noise, including, but not limited to one or more of: an ADS noise model 623-4, subject noise model 623-6, an environmental noise model 623-8, a component noise model 623-9, and so on.

The ADS noise model 623-4 may be configured to model noise introduced by specified types of acquisition devices 104 and/or sensors 105. For example, the ADS noise model 623-4 may be configured to replicate calibration drift, peak broadening, and/or other types of noise introduced by specified types of acquisition devices 104 and/or sensors 105. For example, calibration noise may be modeled by shifting the spectrum data (e.g., shifting the spectrum data up one or more channels, down one or more channels, or the like), broadening noise may be modeled by adjusting the gain on one or more channels, and so on. The ADS noise model 623-4 may be further configured to model noise produced under different operating modes of specified types of acquisition devices 104 and/or sensors 105. For example, the response to an acquisition device 104 may differ when operating in different modes, e.g., in “pulse” mode, “current” mode, or the like. The ADS noise model 623-4 may be configured to model noise introduced by operation of specified types of acquisition devices 104 and/or sensors 105 under different modes or settings. Aspects of the ADS noise model 623-4 may be implemented by the simulation module 604, e.g., the simulation module 604 may be configured to simulate the response of a specified type of acquisition device 104 under different calibration, broadening, and/or drift conditions. For example, ADS noise may be incorporated into SYN SA input data 112 generated by the simulation module. Alternatively, or in addition, the simulation module 604 may be configured to generate ADS noise signal(s) corresponding to varying calibration, drift, and/or other device-specific noise that can be incorporated into RW SA input data 112 (or other SYN SA input data 112).

The subject noise model 623-6 may be configured to model noise introduced by variable subject conditions, such as variations in the orientation between the subject 106 and acquisition device 104. The subject noise model 623-6 may be configured to model noise introduced by changing the distance, angle, and/or other characteristics of the orientation of the subject 106 relative to the acquisition device 104. In some implementations, the aspects of the subject noise model 623-6 may be implemented by the simulation module 604. For example, subject noise may be incorporated into SYN SA input data 112 generated by the simulation module. Alternatively, or in addition, the simulation module 604 may be configured to generate subject noise signal(s) corresponding to varying subject orientations that can be incorporated into RW SA input data 112 (or other SYN SA input data 112).

The environmental noise model 623-8 may be configured to model noise that may be introduced due to various environmental conditions, as disclosed herein, which may include, but are not limited to: temperature within the region 108 in which the spectrum data were captured, air pressure, characteristics of background radiation within the region 108, electromagnetic field(s) within the region 108, and so on. For example, the amount of background radiation in the environment (and resulting noise in the SA input data 112) may vary by physical location. The environmental noise model 623-8 may be configured to generate noise signals configured to model such background noise conditions (and the response of specified acquisition devices 104 and/or sensors 105 to such noise). The environmental noise model 623-8 may be further configured to model the response of specified types of acquisition devices 104 and/or sensors 105 to different environmental conditions, such as temperature, air pressure, and so on. Aspects of the environmental noise model 623-8 may be implemented by the simulation module 604, as disclosed herein. For example, environmental noise may be included in SYN SA input data 112 generated by the simulation module 604. Alternatively, or in addition, the environmental noise model 623-8 may be configured to generate environmental noise signal(s) that can be incorporated into RW SA input data 112 (and/or other SYN SA input data 112).

The component noise model 623-9 may be configured to model noise introduced by components of specified types of acquisition devices 104 and/or sensors 105. More specifically, the component noise model 623-9 may be configured to model the response of specified types of acquisition devices 104 and/or sensors 105 to noise that can be introduced by components and/or external devices. For example, a specified type of acquisition device 104 may comprise a thermocouple that may produce electromagnetic interference under certain conditions. The component noise model 623-9 may be configured to model the response of the specified type of acquisition device 104 to such interference. The component noise model 623-9 may be further configured to model noise that can be introduced by external devices, such as fluorescent lights and/or the like, e.g., may model the response of specified types of acquisition devices 104 to interference produced by such external devices. Aspects of the component noise model 623-9 may be implemented by the simulation module 604, as disclosed herein. For example, component noise may be included in SYN SA input data 112 generated by the simulation module 604. Alternatively, or in addition, the component noise model 623-8 may be configured to generate environmental noise signal(s) that can be incorporated into RW SA input data 112 (and/or other SYN SA input data 112).

As illustrated in FIG. 6, in some implementations, the training data module 610 may further comprise and/or be coupled to a profiler 630. The profiler 630 may be configured to generate training data suitable for training an RML policy 142 to implement a specified target application 130. More specifically, the profiler 630 may be configured to generate training data suitable for training an RML policy 142 to implement a target SA application 130 per SAA metadata 135. As disclosed herein, the SAA metadata 135 may define aspects of an SA application 130, such as the vocabulary of the SA application 130 (e.g., labels 134), characteristics of SA input data 112 to be used in the application, characteristics of SA outputs 122 to be produced in response to respective SA inputs 112 (e.g., labels 134 to be predicted for respective SA inputs 112), and so on. The SAA metadata 135 may further comprise information pertaining to the device(s) and/or environment(s) in which the SA application 130 is to be implemented. For example, the SAA metadata 135 may comprise ADS SAA metadata 135-4, subject SAA metadata 135-6, environmental SAA metadata 135-8, component SAA metadata 135-9, and so on. As disclosed herein, the ADS SAA metadata 135-4 may specify the types of acquisition devices 104 and/or sensor 105 to be used to implement the SA application 130, the subject SAA metadata 135-6 may indicate likely variations in the orientation and/or composition of subjects 106 analyzed in the SA application 130, the environmental SAA metadata 135-8 may comprise information pertaining to the environmental conditions in which the SA application 130 will be performed, the component SAA metadata 135-9 may comprise information pertaining to components likely to be in the vicinity of the acquisition device 104 during implementation of the SA application 130, and so on.

The profiler 630 may be configured to cause the training data module 610 to produce training data suitable for the SA application 130 (per the SAA metadata 135 thereof). In other words, the profiles 630 may be adapted to configure the training data module 610 to generate training datasets 410 adapted for different “uses cases” of an SA application 130. As used herein, the “use case” of an SA application 130 may refer to the conditions under which the SA application 130 is to be implemented, which may be defined by, inter alia, SAA metadata 135 of the different use cases, e.g., the ADS SAA metadata 135-4, subject metadata 135-6, environmental SAA metadata 135-8, component SAA metadata 135-9, and so on. Accordingly, the training data module 610 may generate different training datasets 410 for the same SA application 130, each training dataset 410 adapted to train an RML policy 142 to implement a respective use case of the SA application 130.

For example, the profiler 630 may be adapted to configure the training data module 610 to generate entries 415 comprising SA input data 112 configured to model the response and/or noise characteristics of the acquisition device(s) 104 and/or sensor(s) 105 identified in the ADS SAA metadata 135-4. The profiler 630 may be further adapted to configure the training module 610 to acquire entries 415 comprising SA input data 112 configured to incorporate variable noise per the subject SAA metadata 135-6, e.g., noise resulting from varying orientations of the subject 106 relative to the specified type of acquisition device 104. The profiler 630 may be further adapted to configure the training module 610 to acquire entries 415 comprising SA input data 112 configured to incorporate variable environmental noise, per the environmental SAA metadata 135-8. The profiler 630 may be further adapted to configure the training module 610 to acquire entries 415 comprising SA input data 112 configured to incorporate variable component noise per the component SAA metadata 135-9.

Accordingly, in some implementations, the training data module 610 may be configured to generate a plurality of training datasets 410, each training dataset 410 comprising entries 415 configured to include spectrum data adapted for a particular use case of an SAA application 130. For example, the training data module 610 may generate a first training dataset 410 to train an RML policy 142 to implement a radioisotope spectroscopy SA application 130 using a first type of acquisition device 104 and/or sensor 105, and may generate a second, different training dataset 410 to train an RML policy 142 to implement the radioisotope spectroscopy SA application 130 using a second, different type of acquisition device 104 and/or sensor 105.

In another non-limiting example, the training data module 610 may generate a first training dataset 410 to train an RML policy 142 to implement a radioisotope spectroscopy SA application 130 using a specified type of acquisition device 104 under first environmental conditions, and may generate a second, different training dataset 410 to train an RML policy 142 to implement the radioisotope spectroscopy SA application 130 using the same type of acquisition device 104 under second, different environmental conditions.

In yet non-limiting example, the training data module 610 may generate a first training dataset 410 to train an RML policy 142 to implement a radioisotope spectroscopy SA application 130 using a specified type of acquisition device 104 to capture spectrum data subjects 106 at first orientations under specified environmental conditions, and may generate a second, different training dataset 410 to train an RML policy 142 to implement the radioisotope spectroscopy SA application 130 using the same type of acquisition device 104 to capture spectrum data from subjects at second, different orientations under the same environmental conditions.

Although specific examples of the use of different training datasets 410 to train RML policies 142 to implement SA applications 130 under different conditions are described herein, the disclosure is not limited in this regard and could be adapted to generate training datasets 142 (and trained RML policies 142) to implement any suitable use case of any suitable SA application 130, e.g., tailor SA input data 112 and/or noise signal(s) for specific use cases of the SA applications 130, as disclosed herein.

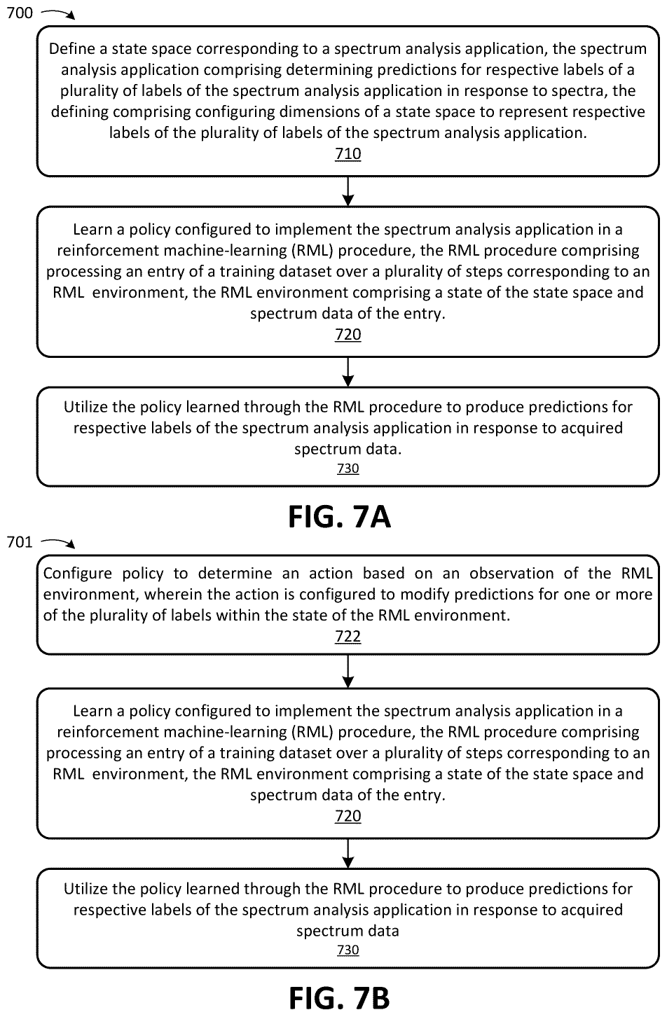

Example methods are described in this section with reference to the flow charts and flow diagrams of FIGS. 7A through 10. These descriptions reference components, entities, and other aspects depicted in FIGS. 1A through 6 by way of example only. FIG. 7A illustrates with a flow diagram an example of a method 700 for reinforcement machine-learned spectrum analysis. The flow diagram illustrating method 700 includes blocks 710 through 730. In some implementations, a device 101 can perform the operations of the method 700 (and operations of the other method flow diagrams illustrated herein). Alternatively, one or more of the operations may be performed by components of the device 101, such as processing resources 102-1, memory resources 102-2, and/or the like.

Step 710 may comprise defining a state space 404 corresponding to a spectrum analysis application (e.g., SA application 130), the spectrum analysis application comprising determining predictions 124 for respective labels 134 of a plurality of labels 134, e.g., labels 134 of a vocabulary of the SA application 130. The defining of 710 may comprise configuring dimensions of the state space 404 to represent respective labels 134 of the plurality of labels of the spectrum analysis application.

Step 720 may comprise learning a policy 142 configured to implement the SA application 130 in an RML procedure 160. The RML procedure 160 may comprise processing an entry 415 of a training dataset 410 over a plurality of steps corresponding to a RML environment 430, the RML environment 430 comprising a state 440 of the state space 404 and spectrum data of the entry 415.

Step 730 may comprise utilizing the policy 142 learned through the RML procedure 160 to produce predictions 124 for respective labels 134 of the SA application in response to acquired spectrum data, e.g., in response to acquired SA inputs 112.

As disclosed herein, in some implementations, the RML procedure 160 may comprise processing a plurality of entries 415, each entry 415 processed in an iterative, multi-step process. In some embodiments, step 720 may further comprise processing the entry 415 at a step of the plurality of steps as illustrated by method 701 of FIG. 7B.

Step 722 may comprise configuring a policy 142 to determine an action 443 based on an observation 445 of the RML environment 430, wherein the action 443 is configured to modify predictions 127 for one or more of the plurality of labels 134 within the state 440 of the RML environment 430.

Step 724 may comprise configuring a critic 144 to determine a reward 447 for the action 443 based, at least in part, on known prediction values for the plurality of labels 134. The critic 144 may be configured to assign rewards 447 in a graded manner. By way of non-limiting example, the reward structure may assign: +10 for an radioisotope quantity prediction(s) 124 with 1% of the actual, +5 within 50%, +2 within 100%, −2 otherwise for each time and/or rollout step.

Step 726 may comprise updating the policy 142 in accordance with the determined reward 447. The updating may be implemented through TD learning. Alternatively, or in addition, the updating may be implemented through PPO with SGD.

Updating the policy 142 at 726 may comprise updating weights of one or more nodes 454 of the first ML component 121.

Referring back to FIG. 7A, training the policy 142 may further comprise instantiating a first ML component 121 configured to implement the policy 142 during the RML procedure 160, the first ML component 121 comprising one or more of an MLP network, an ANN 450, and a CNN, as disclosed herein. In some implementations, the first ML component 121 may comprise a three-level MLP network with one or more of ReLU and tanh activation.

Training the policy 142 at 720 may comprise recording policy configuration data (RML CFG data 150) learned through the RML procedure 160 on a non-transitory computer-readable storage medium, the policy configuration data comprising weights learned for respective nodes of the first ML component 121.

Utilizing the policy 142 learned through the RML procedure 160 may comprise instantiating an ML component 121 in accordance with the learned policy configuration data (e.g., instantiating and/or configuring the ML component 121 per the RML CFG 150). Alternatively, or in addition, utilizing the policy 142 learned through the RML procedure 160 may comprise implementing a hardware ML component 521 in accordance with the RML CFG 150, as disclosed herein.

In some implementations, training the policy 142 at 720 may comprise instantiating a second ML component 121 configured to implement the critic 144 during the RML procedure 160, the second ML component 121 comprising one or more of an MLP network, an ANN 450, and a CNN.

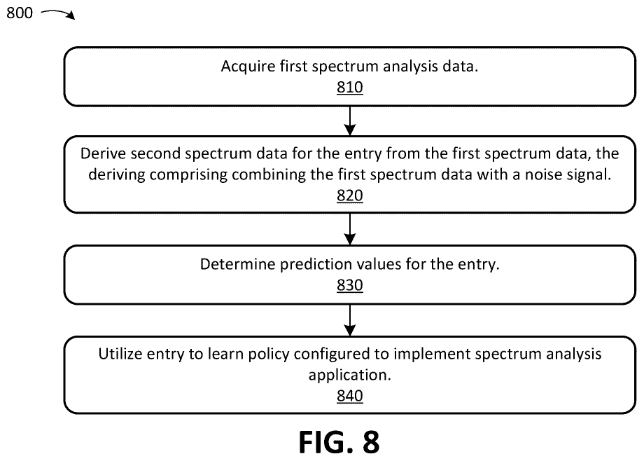

FIG. 8 illustrates an example of a method 800 for generating training data for spectrum analysis. Step 810 may comprise acquiring first spectrum data, such as a first SA input 112, or the like. The first spectrum data may comprise RW spectrum data acquired by use of an acquisition device 104 and/or sensor 105. Alternatively, the first spectrum data may comprise SYN spectrum data generated by a simulation module 604 or the like. The first spectrum data may correspond to a subject 106 associated with known prediction values, e.g., a subject 106 having a known composition of elements or radioisotopes of interest.

Step 820 may comprise deriving second spectrum data for the entry 415 from the first spectrum data, the deriving comprising combining the first spectrum data with a noise signal. In some implementations, the noise signal may be generated by a noise module 620. Alternatively, or in addition, aspects of the noise signal may be generated by the simulation module 604, e.g., during generation of the first SYN spectrum data. In some implementations, the noise signal may be configured to model noise likely to exist in a use case of the SA application 130. The noise signal may be configured to model one or more of, ADS noise, subject noise, environmental noise, component noise, and/or the like. In some implementations, the noise signal may be configured in accordance with SAA metadata 135 of the SA application 130. The noise signal may be configured in accordance with one or more of ADS SAA metadata 135-4, subject SAA metadata 134-6, environmental SAA metadata 134-8, component SAA metadata 134-9, and/or the like. The noise signal may be generated by and/or in accordance with a noise model, such as an ADS noise model 624-4, a subject noise model 624-6, an environment noise model 624-8, a component noise model 624-9, and/or the like. Deriving the second spectrum data may comprise combining the first spectrum data with the noise signal by any suitable method, e.g., combination, additive, convolutional, aggregation, and/or the like.

Step 830 may comprise determining prediction values for the entry 415. Step 830 may comprise determining an ML output 422 comprising known predictions 124 for respective labels 134 of the SA application 130. The prediction values may be determined by a translator 650 of the training data module 610, as disclosed herein. In some implementations, the prediction values may be determined by mapping, converting, and/or translating characteristics of the subject 106 (e.g., the composition, concentration, and/or quantity of respective elements and/or radioisotopes of interest within the subject 106) to predictions 124 for respective labels 134 (e.g., labels configured to represent the respective elements and/or radioisotopes of interest).

The method 800 may, therefore, comprise generating a training dataset 410 to train an RML policy 142 to implement a particular SA application 130 and/or use case of the SA application 130, as disclosed herein.

In some implementations, the method 800 may further comprise including the entry in a training dataset 410 for the SA application 130 and/or utilizing the training dataset 410 to learn an RML policy 142 to implement aspects of the SA application 130 (and/or use case thereof) at 840.

This disclosure has been made with reference to various exemplary embodiments. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general-purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the claims.

We claim:

1. A method for machine-learned spectrum analysis, comprising:
defining a state space corresponding to a spectrum analysis application, the spectrum analysis application comprising determining predictions for respective labels of a plurality of labels of the spectrum analysis application in response to spectra, the defining comprising configuring dimensions of the state space to represent respective labels of the plurality of labels of the spectrum analysis application;
learning a policy configured to implement the spectrum analysis application in a reinforcement machine-learning (RML) procedure, the RML procedure comprising processing an entry of a training dataset over a plurality of steps corresponding to an RML environment, the RML environment comprising a state of the state space and spectrum data of the entry, wherein processing the entry at a step of the plurality of steps comprises:
configuring a policy to determine an action based on an observation of the RML environment, wherein the action is configured to modify predictions for one or more of the plurality of labels within the state of the RML environment,
configuring a critic to determine a reward for the action based, at least in part, on known prediction values for the plurality of labels, and
updating the policy in accordance with the determined reward; and
utilizing the policy learned through the RML procedure to produce predictions for respective labels of the spectrum analysis application in response to acquired spectrum data.

2. The method of claim 1, wherein training the policy further comprises instantiating a first machine-learning (ML) component configured to implement the policy during the RML procedure, the first ML component comprising one or more of a multilayer perceptron (MLP) network, an artificial neural network, and a convolutional neural network.

3. The method of claim 2, wherein the first ML component comprises a three level MLP network with one or more of ReLU and tanh activation.

4. The method of claim 2, wherein updating the policy in accordance with the determined reward comprises updating weights of one or more nodes of the first ML component.

5. The method of claim 4, wherein training the policy further comprises recording policy configuration data learned through the RML procedure on a non-transitory computer-readable storage medium, the policy configuration data comprising weights learned for respective nodes of the first ML component.

6. The method of claim 5, wherein utilizing the policy learned through the RML procedure comprises instantiating an ML component in accordance with the learned policy configuration data.

7. The method of claim 5, wherein utilizing the policy learned through the RML procedure comprises implementing a hardware ML component in accordance with the learned policy configuration data.

8. The method of claim 2, wherein training the policy further comprises instantiating a second ML component configured to implement the critic during the RML procedure, the second ML component comprising one or more of a multilayer perceptron (MLP) network, and artificial neural network, and a convolutional neural network.

9. The method of claim 1, wherein then spectrum analysis application comprises predicting emission quantities for respective radioisotopes, and wherein the method further comprises generating an entry of the training dataset, wherein generating the entry comprises:
acquiring first spectrum data;
deriving second spectrum data for the entry from the first spectrum data, the deriving comprising combining the first spectrum data with a noise signal; and
determining prediction values for the entry based on a composition of a subject associated with the first spectrum data.

10. The method of claim 9, further comprising acquiring the first spectrum data by one or more of:
capturing the first spectrum data from the subject by use of a specified type of acquisition device; and
simulating a response of the specified type of acquisition device to the subject.

11. The method of claim 10, wherein the noise signal is configured to model one or more of: calibration drift exhibited by the specified type of acquisition device, peak broadening exhibited by the specified type of acquisition device, and noise corresponding to an operating mode of the specified type of acquisition device.

12. The method of claim 10, wherein the noise signal is configured to model noise corresponding to environmental conditions, including one or more of: temperature, air pressure, background radiation, and an electromagnetic field.

13. The method of claim 10, wherein the noise signal is configured to model noise corresponding to an orientation of the subject to the specified type of acquisition device.

14. The method of claim 10, wherein the noise signal is configured to model noise introduced by one or more of a component of the specified type of acquisition device and a component of an external device.

15. A device configured to implement an application for radiation spectroscopy, the device comprising:
a processor coupled to a memory; and
a reinforcement machine-learned (RML) policy configured for operation on the processor, the RML policy configured to predict emission values for respective labels in response to spectrum input data, each label configured to represent a respective radioisotope of a plurality of radioisotopes of interest,
wherein the RML policy is learned through an unsupervised RML procedure implemented within an RML architecture comprising an actor and critic, wherein the RML procedure comprises processing entries of a training dataset over a plurality of iterations, each iteration comprising:
configuring the actor to determine an action configured to modify a state comprising predictions for the respective labels,
configuring the critic to determine a reward for the action, and
updating the RML policy of the actor in accordance with the determined reward.

16. The device of claim 15, wherein the RML policy is implemented in one or more of hardware and instructions stored on a non-transitory computer-readable storage medium.

17. A system for spectrum analysis, comprising:
a processor coupled to a memory; and
a training module configured to learn a policy configured to implement a spectrum analysis application, the spectrum analysis application comprising determining predictions for respective labels of a plurality of labels of the spectrum analysis application in response to spectra, the training module comprising:
an RML environment configured to model a state space of the spectrum analysis application, wherein the state space is configured to include dimensions representing respective labels of the spectrum analysis application,
an actor, and
a critic;
wherein the training module is configured to learn the policy through implementation of an RML procedure, the RML procedure comprising processing entries of a training dataset, each entry processed over a plurality of time steps, and wherein processing an entry at a time step t comprises:
configuring the actor to take an action at time step t, the action generated by the policy based on a state of the RML environment at time step t, the state comprising predictions for respective labels of the spectrum analysis application, wherein the action is configured to modify one or more of the predictions,
configuring the critic to determine a reward for the action taken an time step t based, at least in part, on known prediction values for the plurality of labels, and
updating the policy in accordance with the determined reward; and
an RML module configured to utilize the policy learned through implementation of the RML procedure to produce predictions for respective labels of the spectrum analysis application in response to acquired spectrum data.

18. The system of claim 17, further comprising a training data module configured to generate an entry of the training dataset, wherein generating the entry comprises:
acquiring first spectrum data;
deriving second spectrum data for the entry from the first spectrum data by use of a noise module, the noise module configured to combine the first spectrum data with a noise signal; and
determining prediction values for the entry based on a composition of a subject associated with the first spectrum data.

19. The system of claim 18, wherein the training data module is configured to acquire the first spectrum data by use of one or more of:
a specified type of acquisition device; and
a simulation module configured to simulate a response of the specified type of acquisition device to the subject.

20. The system of claim 19, wherein the noise module is configured to generate the noise signal, the noise signal configured to model noise corresponding to one or more of:
calibration drift exhibited by the specified type of acquisition device,
peak broadening exhibited by the specified type of acquisition device,
an operating mode of the specified type of acquisition device,
environmental conditions within a region in which the first spectrum data was acquired,
a temperature within the region,
air pressure within the region,
background radiation within the region,
an electromagnetic field within the region,
an orientation of the subject relative to the specified type of acquisition device,
electromagnetic interference produced by a component of the specified type of acquisition device, and
electromagnetic interference produced by an external device.
